(19) United States
(12) Patent Application Publication
(10) Pub. No.: US 2025/0209266 A1
(43) Pub. Date: Jun. 26, 2025

(54) EVALUATING TYPEAHEAD SUGGESTIONS USING A LARGE LANGUAGE MODEL

(71) Applicant: Microsoft Technology Licensing, LLC, Redmond, WA (US)

(72) Inventors: Xueying Lu, Mountain View, CA (US); Ali Hooshmand, Menlo Park, CA (US); Fan Dong, Los Gatos, CA (US); Jiadong Yin, Santa Clara, CA (US); Raghavan Muthuregunathan, Fremont, CA (US)

(21) Appl. No.: 18/394,915

(22) Filed: Dec. 22, 2023

(51) Int. Cl. G06F 40/274; G06F 40/40

(52) U.S. Cl. CPC G06F 40/274; G06F 40/40

(57) ABSTRACT

Embodiments of the disclosed technologies are capable of evaluating typeahead suggestions using a partial search query. The embodiments describe obtaining a typeahead suggestion responsive to a partial search query. The embodiments further describe creating a prompt based on the typeahead suggestion. The embodiments further describe causing a large language model (LLM) to evaluate the typeahead suggestion based on the prompt. The embodiments further describe providing, to a computing device, an evaluation output by the LLM in response to the prompt.

### TECHNICAL FIELD

Embodiments of the invention relate to the field of typeahead suggestions.

### BACKGROUND

A search engine is a software program that helps people find information online. A user provides search query terms through a search interface. When the user is finished providing the search query terms, the user inputs a signal that tells the search engine to initiate the search. In response to the initiate search signal, the search engine formulates a search based on the input provided by the user prior to the initiate search signal, executes the search to retrieve information related to the search query terms, and provides the retrieved information to the search interface.

### BRIEF DESCRIPTION OF THE DRAWINGS

The invention may best be understood by referring to the following description and accompanying drawings that are used to illustrate embodiments of the invention. In the drawings:

FIG. 1 is a flow diagram of an example method for evaluating typeahead suggestions offline, in accordance with some embodiments of the present disclosure.

FIG. 2 is a flow diagram of an example method for online evaluation of typeahead suggestions, in accordance with some embodiments of the present disclosure.

FIG. 3 illustrates examples of partial search queries and a set of typeahead suggestions, in accordance with one or more embodiments of the present disclosure.

FIG. 4 is an example of a prompt to instruct a machine learning model to evaluate typeahead suggestions, in accordance with some embodiments of the present disclosure.

FIG. 5 is a flow diagram of an example method for fine-tuning a language model using supervised learning, in accordance with some embodiments of the present disclosure.

FIG. 6 is a block diagram of a computing system that includes a typeahead suggestion evaluator, in accordance with some embodiments of the present disclosure.

FIG. 7 is an example of an entity graph, in accordance with some embodiments of the present disclosure.

FIG. 8 is a flow diagram of an example method for evaluating typeahead suggestions, in accordance with some embodiments of the present disclosure.

FIG. 9 is a block diagram of an example computer system including a typeahead suggestion evaluator, in accordance with some embodiments of the present disclosure.

### DETAILED DESCRIPTION

A user can enter a partial search query by typing the first few characters of a word into a text input box of a search interface. There are different types of responses for a given partial search query. For example, in some cases, the user is provided an autocompleted search suggestion based on the partial search query. If selected, the autocompleted search suggestion is then used as a search input to obtain final search results. In other cases, the user is provided with a suggested search result. Suggested search results include a suggested search result for a person (e.g., a person's name), a company, a product, a job entity suggestion (e.g., a search for a job), or knowledge, where knowledge searches can be searches for trending topics, skill queries, and knowledge seeking queries. In some cases, a user is presented with both search suggestions and suggested search results. The suggested search results and search suggestions based on partial search queries are referred to herein as typeahead suggestions presented to a user.

In some cases, typeahead suggestions are ranked in a rank order according to a ranking score, where the typeahead suggestion with the highest-ranking score is presented as the first item in a list (e.g., at the top of the list) and typeahead suggestion with lower ranking scores are presented further down in the list. The position of an item of a typeahead suggestion in a user interface relative to other items of the typeahead suggestion often corresponds to the ranking score of the item.

Given a set of typeahead suggestions, the user can abandon the search (e.g., click elsewhere and/or exit an application), accept a suggestion (e.g., click on an autocompleted search suggestion to initiate a search or click on a suggested search result to obtain a result page), or bypass the typeahead suggestion by searching the partial search query (e.g., pressing enter to initiate the search).

A typeahead suggestion (e.g., suggested search result types such as entity suggested search results, product suggested search results or knowledge suggested search results and/or autocompleted search suggestions) can be a high-quality suggestion (e.g., a suggestion that matches the user's intent) or a low-quality suggestion (e.g., a suggestion that does not match the user's intent). For example, suppose a partial search query of “Alex” is input by a first user, and the first user's search intent is to search for profile information about a person named “Alex V.” In this example, a high-quality typeahead suggestion would be a suggested search result that includes a person named “Alex V” (because the suggestion matches the user's intent of searching for a person) and a low-quality typeahead suggestion would be a suggested search result that includes a product called “Alexa” (because a suggestion to search for a product does not match the user's intent to search for a person). As another example, suppose a partial search query of “Alex” is input by a second user, and the second user's search intent is to search for a product called “Alexa.” In this example, a high-quality typeahead suggestion would be a suggested search result that includes a product called “Alexa” (because the suggestion matches the user's intent of searching for a product) and a low-quality typeahead suggestion would be a suggested search result that includes a person named “Alex V” (because the suggestion to search for a person does not match the user's intent to search for a product).

The technical difficulties associated with partial search queries input by users cause problems such as low-quality typeahead suggestions that are irrelevant to the user search query. High-quality typeahead suggestions account for various motives that a user may have, which involve identifying different suggested search results or autocompleted search results using the same limited search query input. Low-quality typeahead suggestions distract users from their true search intent and decrease the user experience. Additionally, low-quality typeahead suggestions waste computing resources associated with searching for and retrieving irrelevant search results or re-determining typeahead suggestions (e.g., to obtain high-quality typeahead suggestions). In contrast, high-quality typeahead suggestions improve the search ecosystem by increasing a user experience through increased searcher engagement and by increasing downstream activities. Downstream activities are related to user engagement. Examples of such downstream activities include viewing a user profile, adding a user profile to a list of profiles (e.g., connecting with the user profile, following the user profile, saving the user profile), sending a message to a user, saving a user profile, purchasing a product, or downloading digital content.

Thus, a technical challenge is for search systems to provide high-quality and personalized typeahead suggestions based on a partial search query. Typeahead suggestions, unlike landing page results, are limited to a number of characters. The limited number of characters of a typeahead suggestion make typeahead suggestions more difficult to predict, as compared to the prediction of landing page results associated with dense content and more characters. For example, a landing page result can be a web page, which can be crawled to obtain additional information about the landing page result. The information associated with the landing page result can be compared to the partial search query to determine a relevance of the landing page result. In contrast, the relevance of a typeahead suggestion is based on a comparison of the limited characters of the typeahead suggestion and a prediction of the user searcher intent.

Conventionally, search systems employ human evaluators to evaluate the quality of the typeahead suggestion based on a human evaluator's intent when entering the search. Such conventional methods of evaluating typeahead suggestions are costly in terms of the time needed to evaluate a broad range of typeahead suggestions (e.g., suggested search result types such as entity suggested search results, product suggested search results or knowledge suggested search results and/or autocompleted search suggestions). Accordingly, aspects of the present disclosure address the above challenges and other deficiencies by automatically evaluating the quality of typeahead suggestions such that the displayed typeahead suggestions are high quality and personalized.

A generative model uses artificial intelligence technology, e.g., neural networks, to machine-generate new digital content based on model inputs and the previously existing data with which the model has been trained. Whereas discriminative models are based on conditional probabilities P (y|x), that is, the probability of an output y given an input x (e.g., is this a photo of a dog?), generative models capture joint probabilities P (x, y), that is, the likelihood of x and y occurring together (e.g., given this photo of a dog and an unknown person, what is the likelihood that the person is the dog's owner, Sam?).

A generative language model is a particular type of generative model that generates new text in response to model input. The model input includes a task description, also referred to as a prompt. A prompt can be in the form of natural language text, such as a question or a statement, and can include non-text forms of content, such as digital imagery and/or digital audio. The prompt can include instructions and/or examples of content used to explain the task that the generative model is to perform. Modifying the instructions, examples, content, and/or structure of the prompt causes modifications to the output of the model. For example, changing the instructions included in the prompt causes changes to the generated content determined by the model.

Prompt engineering is a technique used to optimize the structure and/or content of the prompt input to the generative model. Some prompts can include examples of outputs to be generated by the generative model (e.g., few-shot prompts), while other prompts can include no examples of outputs to be generated by the generative model (e.g., zero-shot prompts). Chain of thought prompting is a prompt engineering technique where the prompt includes a request that the model explain reasoning in the output. For example, the generative model performs the task provided in the prompt using intermediate steps where the generative model explains the reasoning as to why it is performing each step.

A large language model (LLM) is a type of generative language model that is trained using an abundance of data (e.g., publicly available data) such that billions of hyperparameters that define the LLM are used to learn a task. Some pretrained LLMs, such as generative pretrained transformers (GPT) can be trained to perform tasks including natural language processing (NLP) tasks such as text extraction, text translation (e.g., from one language to another), text summarization, and text classification.

Implementations of the described approaches evaluate typeahead suggestions for each of the various suggested search result types (e.g., entity suggested search results, product suggested search results or knowledge suggested search results). Entity suggested search results can include searches for people (e.g., user profiles), searches for companies, and/or searches for products. Implementations of the described approaches can also evaluate typeahead suggestions for search suggestions (e.g., based on autocompleting a partial search input) using an LLM and unique quality measurements for each suggested search result type and search suggestion. Further, implementations of the described approaches use context data associated with a partial search query to simulate the user's intent. Examples of context data include the user's search history, the user's previous activity within the same online session or across previous sessions, the user's profile data (e.g., job title, geographic location, etc.), the number of characters in the partial search query (e.g., the number of characters already typed, also referred to as query length), and the amount of time elapsed between user actions (e.g., how long did the user pause after entering an input, also referred to as a debouncing period).

Implementations of the described approaches configure an LLM to evaluate typeahead suggestions based on a simulated user search intent. Evaluating typeahead suggestions determined by one or more upstream systems or processes configured to generate the typeahead suggestions causes the one or more upstream systems or processes to generate high-quality and personalized typeahead suggestions reliably. As described above, high-quality and personalized typeahead suggestions improve the search ecosystem by increasing downstream activities and decreasing the consumption of computing resources dedicated to irrelevant (low-quality) search queries or search results.

The disclosed technologies are described in the context of a search system of an online network-based application software system. For example, news and entertainment apps installed on mobile devices, messaging systems, and social graph-based applications can all function as application software systems that include search systems. An example of a search use case is a user of an online system searching for jobs or job candidates over a professional social network that includes information about companies, job postings, and users of the online system.

Aspects of the disclosed technologies are not limited to social network applications but can be used to improve search systems more generally. The disclosed technologies can be employed by many different types of network-based applications in which a search interface is provided, including but not limited to various types and forms of application software systems.

The disclosure will be understood more fully from the detailed description given below, which references the accompanying drawings. The detailed description of the drawings is for explanation and understanding and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains but can be used with or incorporated into other embodiments, including embodiments shown in other drawings.

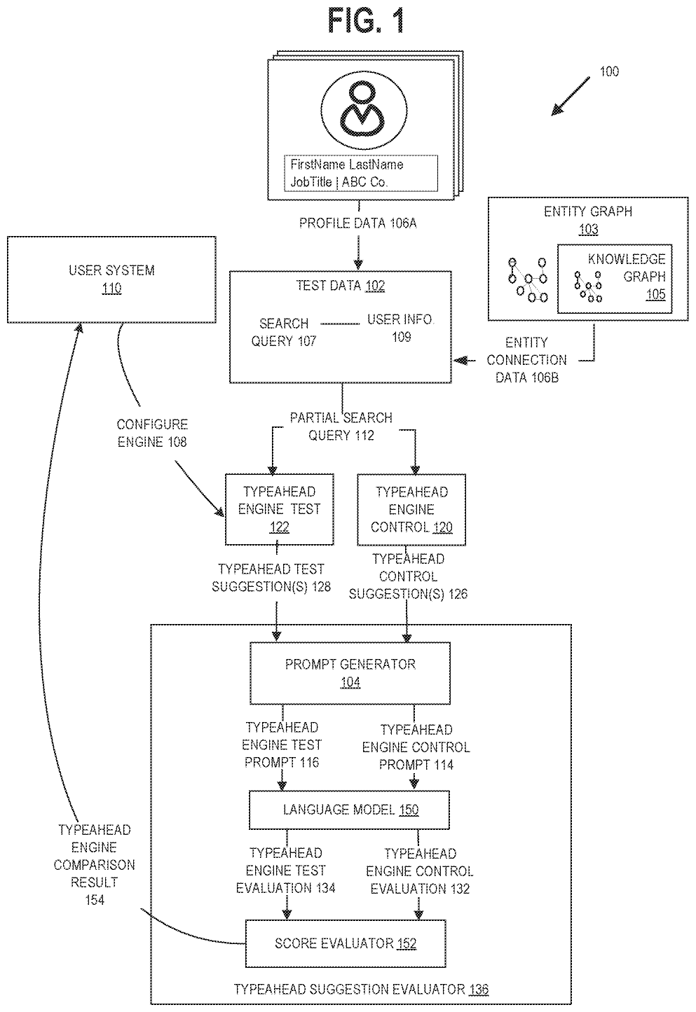

FIG. 1 is a flow diagram of an example method for evaluating typeahead suggestions offline, in accordance with some embodiments of the present disclosure.

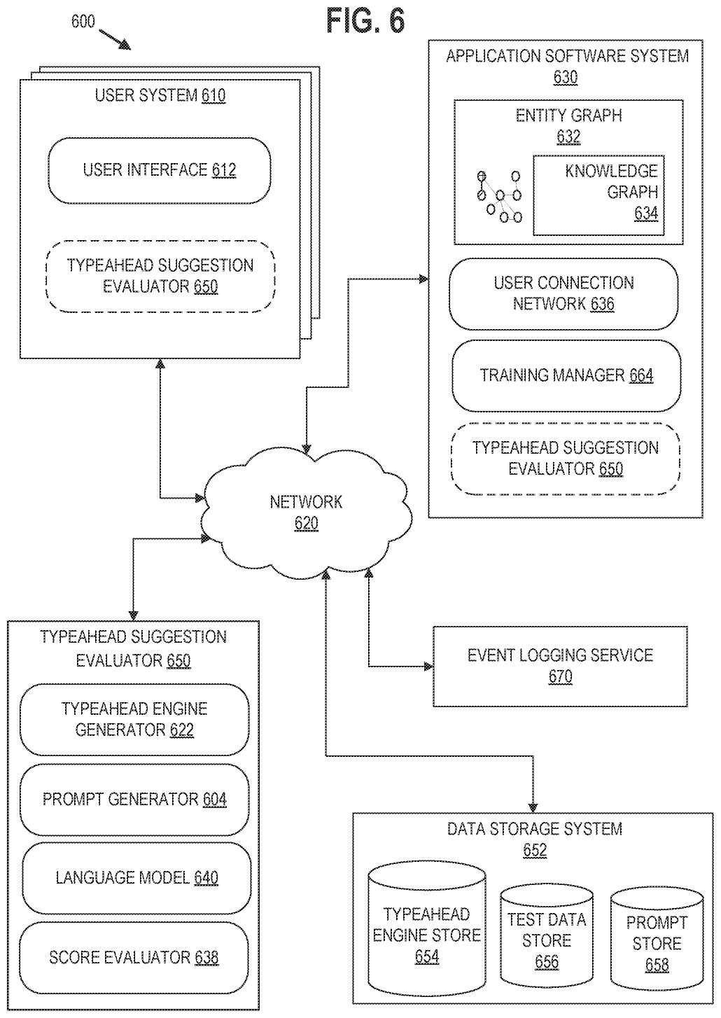

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of a typeahead suggestion evaluator 650 of FIG. 6, including, in some embodiments, components shown in FIG. 6 that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 1, computing system 100 includes a user system 110, a typeahead engine test 122, a typeahead engine control 120, and a typeahead suggestion evaluator 136. The suggestion evaluator 136 includes a prompt generator 104, language model 150, and a score evaluator 152. In the example of FIG. 1, the components of the typeahead suggestion evaluator 136 are implemented using an application server or server cluster, which can include a secure environment (e.g., secure enclave, encryption system, etc.) for the processing of message data.

As indicated in FIG. 1, components of computing system 100 are distributed across multiple different computing devices, e.g., one or more client devices, application servers, web servers, and/or database servers, connected via a network, in some implementations. In other implementations, at least some of the components of computing system 100 are implemented on a single computing device such as a client device. For example, some or all of the typeahead suggestion evaluator 136 is implemented directly on the user's client device in some implementations, thereby avoiding the need to communicate with servers over a network such as the Internet.

User system 110 includes at least one computing device, such as a personal computing device, a server, a mobile computing device, or a smart appliance. A user using user system 110 may configure 108 one or more aspects of the typeahead engine test 122. For example, a user modifies one or more parameters of the typeahead engine test 122 (e.g., one or more hyperparameters such as the number of layers in a neural network model, the number of neurons in one or more layers of the neural network model, the loss function used to train the neural network model, one or more bias terms, or one or more momentum terms). In some implementations, the user configures 108 typeahead engine test 122 to be a different typeahead suggestion model from the typeahead engine control 120, and/or the user configures 108 the typeahead engine test 122 to be trained differently (using different training data, for instance) from the typeahead engine control 120. As a result, one or more typeahead control suggestions 126 are different from the one or more typeahead test suggestions 128.

The typeahead suggestion evaluator 136 compares the typeahead engine test suggestions 128 determined from the typeahead engine test 122 to the typeahead control suggestions 126 determined from the typeahead engine control 120. The typeahead engine test evaluation 134 is compared against the typeahead engine control evaluation 132 to determine which typeahead engine (e.g., typeahead engine test 122 or typeahead engine control 120) provided more high-quality typeahead suggestions (e.g., based on the typeahead test suggestions 128 or typeahead control suggestions 126). Accordingly, a user can determine whether the configurations 108 improved the performance of the typeahead engine test 122 or not.

Test data 102 is the data used to evaluate the typeahead engine test 122 and the typeahead engine control 120. Test data 102 includes pairs of search queries 107 and corresponding user information 109 associated with the search query 107. User information 109 can include profile data 106A and/or entity connection data 106B. The user information 109 can be obtained from a variety of different data sources including user interfaces, databases and other types of data stores, including online, real-time, and/or offline data sources. In the example of FIG. 1, profile data 106a is received via one or more web servers and entity connection data 106b is received via one or more database servers.

Examples of profile data 106a include user experience, interests, areas of expertise, educational history, job titles, skills, job history, etc. Profile data 106a can be obtained for the test data 102 by querying one or more data stores that store entity profile data for an application software system.

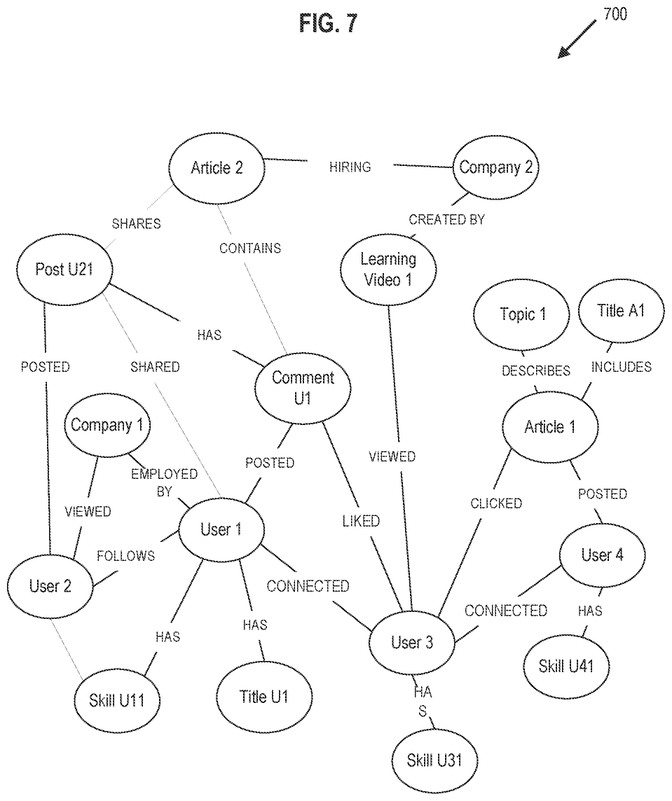

Examples of entity connection data 106b include data extracted from entity graph 103 and/or knowledge graph 105. For example, one or more other components (not shown) traverse the entity graph 103 and/or knowledge graph 105 for entity connection data 106b associated with profile data 106a. The entity graph 103 includes entity profile data arranged according to a connection graph, e.g., a graph of connections and relationships between users of the user connection network and between users and other entities. For example, the entity graph 103 represents entities as nodes and relationships between entities as edges between the nodes. In some implementations, entity graph 103 includes a cross-application knowledge graph 105. The cross-application knowledge graph 105 is a subset of the entity graph 103 or a superset of the entity graph 103 (e.g., a combination of multiple entity graphs) that links data from the user connection network with data from other application software systems, such as a user connection network or a search engine. Entity connection data 106b is extracted from an application software system operating the entity graph 103 or knowledge graph 105 by, for example, traversing the entity graph 103 or knowledge graph 105, e.g., by executing one or more queries on one or more data stores that store data associated with the nodes and edges of the entity graph 103 or knowledge graph 105. An example of an entity graph or cross-application knowledge graph is shown in FIG. 7, described herein.

The search query 107 is partitioned into a subset of characters used for the partial search query 112. For example, the partial search query 112 can be the first four characters of a set of 10 characters of the completed search query 107.

In some embodiments, pairs of search queries 107 and corresponding user information 109 are randomly sampled from a set of stored search queries and corresponding user information to obtain test data 102.

In other embodiments, test data 102 includes specific user information 109 and corresponding search queries 107. For example, test data 102 includes user information 109 of users who have recently accessed or otherwise updated their user profile during a predefined time period (e.g., the profile has been accessed in the last day, the last week, or the last month).

In some embodiments, test data 102 includes search queries 107 associated with specific search sessions. For example, some search queries result in the user clicking on a typeahead suggestion, some search queries result in the user bypassing the typeahead suggestion, and some search queries result in the user abandoning the search. Including search queries associated with a diverse set of search sessions allows the typeahead engine to produce typeahead suggestions associated with successful search sessions (e.g., the user clicked on the typeahead suggestion), bypassed search sessions (e.g., the user initiated a search with a partial search query, where the partial search query is the stored search query), and abandoned search sessions (e.g., the user exited the search). In some embodiments, the test data 102 includes a distribution of session types associated with search queries 107. For example, the test data 102 includes a distribution of search queries 107 that include 40% search queries 107 that resulted in abandoned search sessions (e.g., pairs of search queries 107 and corresponding user profiles 109), 45% search queries 107 that resulted in successful search sessions, and 25% search queries 107 that resulted in bypassed search sessions. Other distributions of search sessions are possible.

In some embodiments, test data 102 includes specific search queries 107 and corresponding user information 109. For example, search queries 107 can be tagged with associated types of typeahead suggestions based on a clicked-on typeahead suggestion of a successful search session. The selected typeahead suggestion represents the user's search intent. For example, a user's selection of a person typeahead suggestion represents the user's search intent related to a person search. Accordingly, the search query 107 of the successful search session can be tagged with “entity suggested search result” as the type of suggested search result. In another example, a user's selection of a product typeahead suggestion represents the user's search intent related to a product search. Accordingly, the search query 107 of the successful search session can be tagged with “product suggested search result” as the type of suggested search result.

The test data 102 can include a distribution of types of typeahead suggestions using the tagged typeahead suggestion type associated with successful search sessions. For example, the test data 102 includes a distribution of 15% search queries 107 that are tagged with “entity suggested search result,” (e.g., pairs of search queries 107 and corresponding user profiles 109), 15% search queries 107 that are tagged with “product suggested search result,” 15% search queries 107 that are tagged with “job suggested search result,” and 55% search queries 107 that are tagged with “knowledge suggested search result.” Other distributions of search sessions are possible.

In some embodiments, the knowledge suggested search result is further tagged. For example, the knowledge suggested search result can be related to a skill query (and therefore include a “skill query knowledge suggested search result”), a topic query (and therefore include a “topic query knowledge suggested search result”), and a question query (and therefore include a “question query knowledge suggested search result.”) A skill query relates to a search for knowledge regarding a type of skill (e.g., how to code in Python?), a topic query relates to a search for knowledge regarding a topic (e.g., what is the state of artificial general intelligence?), and a question query relates to a search for knowledge regarding a specific question (e.g., how many employees does Company XYZ employ?).

Both the typeahead engine control 120 and the typeahead engine test 122 receive the partial search query 112. In some embodiments, the partial search query 112 is passed to both the typeahead engine control 120 and the typeahead engine test 122 after every character of the search query 107, mimicking a partial search query 112 input of user keystrokes. In other embodiments, the partial search query 112 is passed to both the typeahead engine control 120 and the typeahead engine test 122 at a syllable boundary of the search query 107. For example, a user enters a number of characters up to a specific syllable and then pauses. The pause may represent a syllable boundary and the characters entered are the partial search query 112.

The typeahead engine control 120 suggests one or more control typeahead suggestions 126 based on the partial search query 112 using any one or more typeahead suggestion techniques. The typeahead engine test 122 suggests one or more test typeahead suggestions 128 based on the partial search query 112 using any one or more typeahead suggestion techniques. One example typeahead suggestion technique includes using embedding based retrieval to obtain typeahead suggestions that are semantically similar to the partial search query 112. Another example typeahead suggestion technique includes using a language model to generate typeahead suggestions. For instance, given a partial search query 112, the typeahead engine (e.g., typeahead engine test 122 and/or typeahead engine control 120) can predict the next one or more tokens using a probability distribution of tokens determined by the typeahead engine. Yet another example typeahead suggestion technique includes using a graph database. For instance, the typeahead engine (e.g., typeahead engine test 122 and/or typeahead engine control 120) can traverse one or more nodes of the graph database to determine a most likely typeahead suggestion.

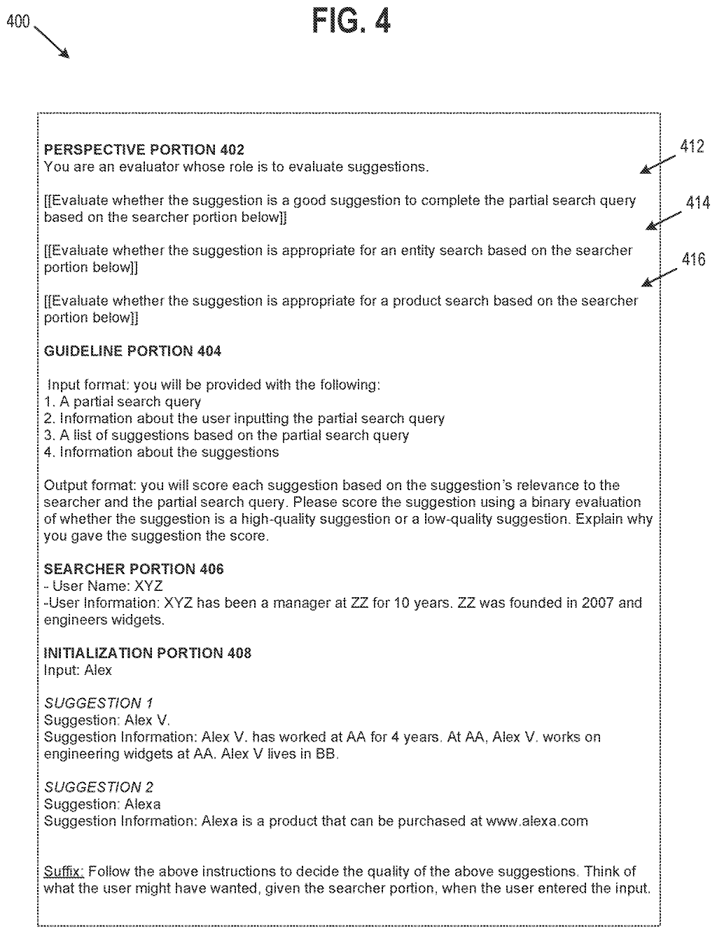

As described herein, there are multiple different types of typeahead suggestions. For example, given the partial search query 112, the typeahead engine (e.g., either typeahead engine test 122 and/or typeahead engine control 120) can suggest an autocompleted search suggestion. For instance, given a partial search query 112 that includes a subset of characters of a completed search query, the autocompleted search suggestion is the predicted full set of characters of the search query 107. Additionally, or alternatively, given the partial search query 112, the typeahead engine (e.g., either typeahead engine test 122 and/or typeahead engine control 120) can suggest a suggested search result of multiple suggested search result types. For instance, given a partial search query 112, the typeahead engine can suggest an entity suggested search result, a product suggested search result, a job entity suggested search result, or a knowledge suggested search result (e.g., a skill query knowledge suggested search result, a topic query knowledge suggested search result, or a question query knowledge suggested search result). Accordingly, the prompt generator 104 generates a prompt, instructing the language model 150 to evaluate possible types of typeahead suggestions. The prompt generator 104 generates typeahead engine control prompt 114 instructing the language model 150 to evaluate the typeahead control suggestions 126 and the typeahead engine test prompt 116 instructing the language model 150 to evaluate the typeahead test suggestions 128. In some embodiments, a single typeahead engine control prompt 114 evaluates one or more types of typeahead control suggestions 126 and a single typeahead engine test prompt 116 evaluates one or more types of typeahead test suggestions 128. In other embodiments, the prompt generator 104 generates multiple prompts (e.g., multiple typeahead engine control prompts 114 and multiple typeahead engine test prompts 116), each prompt instructing the language model 150 to evaluate one or more types of typeahead suggestion. An example prompt is described in FIG. 4.

As described herein, typeahead suggestions are based, in part, on the user intent when inputting the partial search query. To simulate a user intent, the prompt generator 104 includes user information 109 in each prompt. Incorporating user information 109 into the typeahead engine test prompt 116 and the typeahead engine control prompt 114 provides contextual information to the language model 150, thereby filling in information gaps otherwise associated with partial search queries. For example, a job recruiter, determined using user information 109, is more likely to search for people as opposed to products, thereby making typeahead suggestions of people named Alex higher quality typeahead suggestions than typeahead suggestions of a product “Alexa” given a partial search query “Alex.”

The typeahead engine test prompt 116 is different from the typeahead engine control prompt 114 by virtue of the different typeahead test suggestions. For example, the typeahead engine test prompt 116 includes one or more typeahead test suggestions 128. Similarly, the typeahead engine control prompt 114 includes one or more typeahead control suggestions 126.

While the typeahead suggestions of each prompt vary, the instructions of the typeahead engine test prompt 116 and the typeahead engine control prompt 114 are the same. Accordingly, a typeahead engine test prompt 116 with a first evaluation instruction evaluates a typeahead engine test suggestion 128 using a partial search query 112 based on a search query 107 and a corresponding user profile 109. Similarly, a typeahead engine control prompt 114 with the first evaluation instruction evaluates a typeahead engine control suggestion 126 using a partial search query 112 based on the complete search query 107 and the corresponding user profile 109. In this manner, the quality of the typeahead suggestions is evaluated given the same evaluation instructions, the same partial search query, and the same user profile.

The language model 150 can be any LLM. The prompt generator 104 instructs the language model 150 to assume the role of a typeahead evaluator and evaluate the typeahead suggestion(s) included in both the typeahead engine test prompt 116 and the typeahead engine control prompt 114. While the language model 150 is illustrated as receiving both the typeahead engine prompt 116 and the typeahead engine control prompt 114 in parallel, in some embodiments, the language model 150 receives the typeahead engine prompt 116 and the typeahead engine control prompt 114 in series such that the language model 150 evaluates the typeahead suggestions of a first prompt and subsequently evaluates the typeahead suggestions of a second prompt.

The language model 150 determines a typeahead engine test evaluation 134 of the typeahead test suggestions 128 and a typeahead engine control evaluation 132 of the typeahead control suggestions 126. The language model 150 evaluates the typeahead test suggestions 128 and the typeahead control suggestions 126 using the partial search query 112 and the user information 109 included in the typeahead engine test prompt 116 and the typeahead engine control prompt 114. In operation, the language model 150 simulates a user search intent using the user information 109. In some embodiments, the language model 150 rates each typeahead suggestion as being a high-quality typeahead suggestion or a low-quality typeahead suggestion. That is, the language model 150 performs a binary classification of each typeahead suggestion. In other embodiments, the language model 150 rates each typeahead suggestion using a scale. That is, the language model 150 rates each typeahead suggestion on a scaled quality rating such as normalized discounted cumulative gain (NDCG). Evaluating the quality of each typeahead suggestion using a scaled quality rating can be a more representative evaluation score than evaluating the quality of each typeahead suggestion using a binary rating. For example, a scaled quality rating score of a typeahead suggestion scores the typeahead suggestion with respect to the ranking position in a set of typeahead positions. In other words, the quality of the typeahead suggestion is evaluated based on the position of the typeahead suggestion in a list of typeahead suggestions. In addition to evaluating the quality of each typeahead suggestion, the language model 150 outputs a reason for the evaluation. Accordingly, the typeahead engine test evaluation 134 includes an indication of each typeahead suggestion (e.g., typeahead test suggestion 128) being a high-quality or low-quality typeahead suggestion (or a relevancy score of each typeahead suggestion) and a reason for the evaluation score. Similarly, the typeahead engine control evaluation 132 includes an indication of each typeahead suggestion (e.g., typeahead control suggestion 126) being a high-quality or low-quality typeahead suggestion (or a relevancy score of each typeahead suggestion) and a reason for the evaluation score.

The score evaluator 152 compares the typeahead engine test evaluation 134 and the typeahead engine control evaluation 132 to determine whether the typeahead engine test 122 outperformed the typeahead engine control 120 (e.g., in terms of providing more high-quality typeahead suggestions). In some embodiments, the score evaluator 152 accumulates evaluations such that the score evaluator can evaluate the typeahead engine test 122 and the typeahead engine control 120 based on a number of pairs of search queries 107 and user information 109 of the test data 102. For example, the score evaluator 152 scores the typeahead engine test 122 and the typeahead engine control 120 once the score evaluator 152 has received evaluation scores of 50% of pairs of search queries 107 and user information 109 of the test data 102. In other embodiments, the score evaluator 152 scores the typeahead engine test 122 and the typeahead engine control 120 once the score evaluator 152 has received all of the pairs of search queries 107 and user information 109 of the test data 102.

In some embodiments, the score evaluator 152 averages each of the typeahead suggestion scores included in the typeahead engine test evaluation 134 and the typeahead engine control evaluation 132. For example, if the language model 150 makes a binary classification of whether each typeahead suggestion (e.g., typeahead test suggestion 128 and typeahead control suggestion 126), the language model 150 can score each typeahead suggestion as having a “1” for being a high-quality typeahead suggestion and a “0” for being a low-quality typeahead suggestion. If the language model 150 assigned a relevancy score using one or more algorithms such as the NDCG algorithm, the language model 150 can score each typeahead suggestion on a range from 0-5, for instance.

The score evaluator 152 averages the scores of the one or more typeahead engine test evaluations 134 and typeahead engine control evaluations 132 respectively to determine a final score associated with the typeahead test suggestions 128 provided by the typeahead engine test 122 and the typeahead control suggestions 126 provided by the typeahead engine control 120. In some embodiments, the score evaluator 152 compares the final score associated with each typeahead engine to determine a typeahead engine comparison result 154. The typeahead engine associated with the higher final score, for instance, is determined to be the typeahead engine that provides more high-quality typeahead suggestions.

The score evaluator 152 passes the typeahead engine comparison result 154 to the user system 110 such that the user system can make further modifications to the typeahead engine test 122 and/or save the results of the typeahead engine comparison result 154. In some embodiments, the score evaluator 152 also passes the typeahead engine test evaluation 134 and typeahead engine control evaluation 132 such that a user at the user system 110 has access to the language model 150 reasoning associated with each evaluation score.

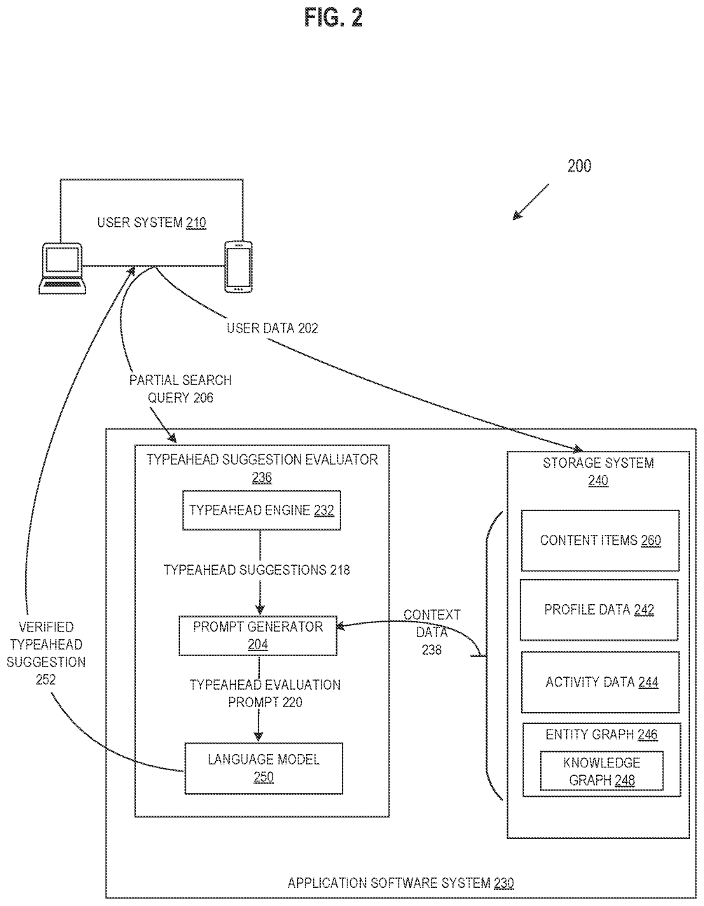

FIG. 2 is a flow diagram of an example method for online evaluation of typeahead suggestions, in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of the typeahead suggestion evaluator 236, including, in some embodiments, components shown in FIG. 1 of the typeahead suggestion evaluator 136 that may not be specifically shown in FIG. 6, or by components shown in any of the figures that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 2, in the example computing system 200, an example application software system 230 is shown, which includes a typeahead suggestion evaluator 236 and a storage system 240. The typeahead suggestion evaluator 236 of FIG. 2 includes a typeahead engine 232, a prompt generator 204 and a language model 250. In the example of FIG. 2, the components of the application software system 230 are implemented using an application server or server cluster. In other implementations, one or more components of the application software system 230 are implemented on a client device, such as a user system 610, described herein with reference to FIG. 6. In yet other implementations, the components of the typeahead suggestion evaluator 236 are executed as an application or service, executed remotely or locally.

User system 210 includes at least one computing device, such as a personal computing device, a server, a mobile computing device, or a smart appliance. User system 210 includes at least one software application, enabling the user system 210 to bidirectionally communicate with the application software system 230. Additionally, the user system 210 includes a user interface that allows a user to input the partial search query 206 and display verified typeahead suggestions 252.

Application software system 230 is any type of application software system that provides or enables at least one form of digital content distribution or social networking service to user using user system 210. Examples of application software system 230 include but are not limited to connections network software, such as social media platforms, and systems that are or are not based on connections network software, such as general-purpose search engines, job search software, recruiter search software, sales assistance software, content distribution software, learning and education software, or any combination of any of the foregoing.

Application software system 230 may refer to a software application that is considered the owner of particular data or that has been granted permission by a user to use certain data. For example, an application that requires users to agree to a set of terms and conditions regarding data security may be considered an application with respect to data created as a result of the users' use of the application software system 230. In some embodiments, the application software system 230 receives one or more user credentials from user system 210, allowing the user to access one or more applications or digital content provided by the application software system 230. In some embodiments, the application software system 230 is configured to authorize the user system 210 based on the user credentials matching a stored set of user credentials.

As shown, the storage system 240 stores user data 202 associated with a user of the user system 210. In some embodiments, every time the user system 210 interacts with one or more applications of the application software system 230 (e.g., such as a search engine that calls typeahead engine 232), the storage system 240 logs and/or stores the user interaction. A user of the user system 210 interacts with applications, services, and/or content presented to the user. As described with reference to FIG. 6, the application software system 230 may include an event logging service 670. The logged activity is stored as activity data 244 in the storage system 240. The activity data 244 can include content viewed, links or buttons selected, messages responded to, etc.

For example, when a user interacts with an application of the application software system 230, the user may provide personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. Some or all of such information can be stored as profile data 242. Profile data 242 may also include profile data of various organizations/entities (e.g., companies, schools, etc.).

In some embodiments, when a user interacts with an application of the application software system 230 (e.g., via user data 202), the user engages with one or more other users of the application software system 230 and/or content provided by the application software system 230. As a result, the entity graph 246, which represents entities, such as users, organizations (e.g., companies, schools, institutions), and content items (e.g., user profiles, job postings, announcements, articles, comments, and shares), updates nodes of the graph. As described herein, entity graph 246 represents relationships, also referred to as mappings or links, between or among entities as edges, or combinations of edges, between the nodes of the graph. In some implementations, mappings between or among different pieces of data are represented by one or more entity graphs (e.g., relationships between different users, between users and content items, or relationships between job postings, skills, and job titles). In some implementations, the edges, mappings, or links of the entity graph 246 indicate online interactions or activities relating to the entities connected by the edges, mappings, or links. For example, if a user views and accepts a message from another user, an edge may be created connecting the message-receiving user entity with the message-sending user entity in the entity graph, where the edge may be tagged with a label such as “accepted.”

Portions of entity graph 246 can be automatically re-generated or updated from time to time based on changes and updates to the stored data, e.g., in response to updates to entity data and/or activity data from a user. Also, entity graph 246 can refer to an entire system-wide entity graph or to only a portion of a system-wide graph, such as a sub-graph. For instance, entity graph 246 can refer to a sub-graph of a system-wide graph, where the sub-graph pertains to a particular entity or entity type.

Not all implementations have a knowledge graph, but in some implementations, knowledge graph 248 is a subset of entity graph 246 or a superset of entity graph 246 that also contains nodes and edges arranged in a similar manner as entity graph 246 and provides similar functionality as entity graph 246. For example, in some implementations, knowledge graph 248 includes multiple different entity graphs 246 that are joined by cross-application or cross-domain edges or links. For instance, knowledge graph 248 can join entity graphs 246 that have been created across multiple different databases or across multiple different software products. As an example, knowledge graph 248 can include links between content items that are stored and managed by a first application software system and related content items that are stored and managed by a second application software system different from the first application software system. Additional or alternative examples of entity graphs and knowledge graphs are shown in FIG. 7, described below.

Other examples of data that can be stored at storage system 240 include content items 260. For example, the storage system 240 stores content items 260 including users registered to the application software system 230, articles posted or uploaded to the application software system 230, products offered by the application software system 230, and other information. The content items 260 include any digital content that can be displayed using the application software system 230.

As shown in the example of FIG. 2, in operation, the typeahead engine 232 receives a partial search query 206 from user system 210. As described herein, the partial search query 206 can be a subset of one or more characters included in the set of characters of the completed search query. For example, the partial search query 206 can be the first four characters of a set of 10 characters of a completed search query. In some embodiments, the partial search query 206 is passed to the typeahead engine 232 after every keystroke entered by a user at the user system 210. That is, the partial search query 206 is a single character. In other embodiments, the partial search query 206 is passed to the typeahead engine 232 at a syllable boundary. In other embodiments, the partial search query 206 is passed to the typeahead engine 232 after a predetermined time period (e.g., a delay of 2 ms is detected after a last received keystroke of the partial search query 206) and/or a predetermined number of characters (e.g., after receiving four characters). In some embodiments, the partial search query 206 is tagged with user profile information associated with a user at the user system 210 entering the partial search query 206. For example, the profile information can include a profile identifier (e.g., a number, a username, or an IP address), that links the user profile to corresponding profile data 242, activity data 244, and/or one or more nodes of the entity graph 246 or knowledge graph 248.

The typeahead engine 232 executes a typeahead service to obtain a set of one or more typeahead suggestions 218 using the partial search query 206. In some implementations, the typeahead suggestions 218 are arranged in rank order. The process by which the typeahead engine 232 service generates and ranks typeahead suggestions 218 is not specifically shown in FIG. 2 but generally includes ranking a set of search suggestions based on the partial search query 206. For example, the typeahead suggestion that is displayed in the first position of a list of selectable typeahead suggestions has the highest probability of corresponding to partial search query 206.

The typeahead engine 232 passes the typeahead suggestions 218 and the partial search query 206 to the prompt generator 204. The prompt generator 204 generates typeahead evaluation prompt 220, similar to the typeahead evaluation prompt 400 described in FIG. 4. For example, the prompt 220 can include one or more evaluation instructions (such as evaluation instructions 412-414 described in FIG. 4) to evaluate the prompt with respect to autocompleted search suggestions and/or suggested search results. The diverse range of user search intent can be evaluated according to a diverse set of evaluation instructions. The evaluation instructions instruct the language model 250 how to evaluate a typeahead suggestion based on the user search intent and/or different types of typeahead suggestions. The user search intent is predicted using context data 238.

The typeahead evaluation prompt 220 includes context data 238 such as profile data 242, activity data 244, and/or information obtained from the entity graph 246 or knowledge graph 248 based on profile information tagged with the partial search query 206. The typeahead evaluation prompt also includes the typeahead suggestions 282 determined by the typeahead engine 232 and the partial search query 206.

The language model 250 evaluates the typeahead suggestions 218 based on the partial search query 206 and a predicted user search intent based on context data 238. In some embodiments, the language model 250 rates each typeahead suggestion as being a high-quality typeahead suggestion or a low-quality typeahead suggestion. That is, the language model 250 performs a binary classification of each typeahead suggestion. In other embodiments, the language model 250 rates each typeahead suggestion using a scale. That is, the language model 250 independently rates each typeahead suggestion on a relevancy scale such as NDCG.

In operation, the language model 250 uses the predicted user search intent to evaluate the typeahead suggestions with respect to possible suggested search result types and/or autocompleted search suggestions. The language model 250 determines whether the typeahead suggestions are meaningful, given the language model's simulation of the user associated with user system 210 entering the partial search query 206.

In some embodiments, only a subset of the typeahead suggestions 218 is displayed to a user of the user system 210. For example, only typeahead suggestions that are determined to be high-quality typeahead suggestions are passed to the user system 210 as verified typeahead suggestions 252. The typeahead suggestions determined to be low-quality typeahead suggestions are not passed to the user system 210. The verified typeahead suggestions 252 are displayed to the user at the user system 210. In operation, typeahead suggestions 218 that receive an indication of being a high-quality typeahead suggestion are passed to the user system 210, and typeahead suggestions 218 that receive an indication of being a low-quality typeahead suggestion are not passed to the user system 210. In some embodiments, a score of the typeahead suggestion is compared to a threshold to determine whether the typeahead suggestion is a high-quality typeahead suggestion or a low-quality typeahead suggestion.

While the typeahead engine 232, the prompt generator 204, and the language model 250 are illustrated as separate components of the typeahead suggestion evaluator 236, in some embodiments, a model generates typeahead suggestions and also evaluates the generated typeahead suggestions. For example, the language model 250 generates typeahead suggestions 218 using the partial search query 206, the prompt generator 204 generates a typeahead evaluation prompt 220 using context data 238 and the generated typeahead suggestions, and the language model 250 evaluates the typeahead suggestions using the typeahead evaluation prompt 220.

The examples shown in FIG. 2 and the accompanying description above are provided for illustration purposes. This disclosure is not limited to the described examples. Additional or alternative details and implementations are described herein.

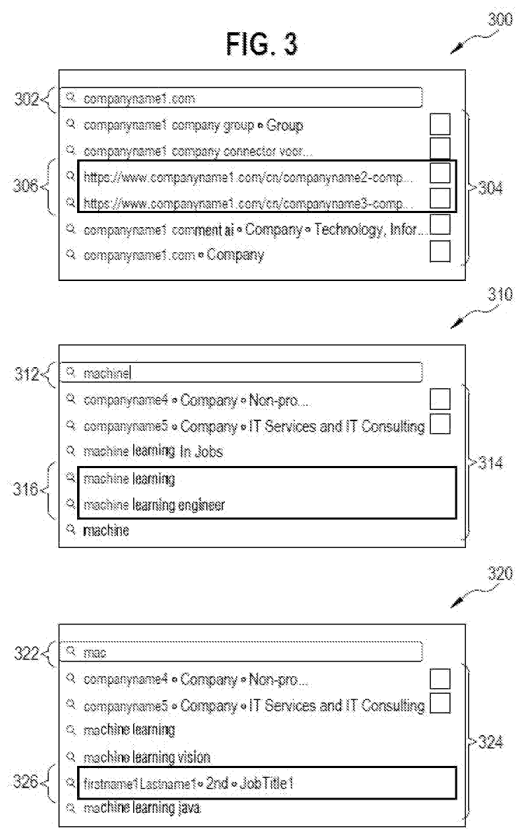

FIG. 3 illustrates examples of partial search queries and a set of typeahead suggestions, in accordance with one or more embodiments of the present disclosure.

In example 300, the partial search query 302 “companyname1.com,” results in the set of typeahead suggestions 304. In example 300, the user intent associated with searching “companyname1.com” is the Company Name 1, by virtue of the user knowing many people employed by Company Name 1. Such user information is obtained, for example, by traversing the entity graph and/or knowledge graph associated with the user profile. Each of the typeahead suggestions 304 are evaluated using the systems and methods described herein. As shown in example 300, at least the two typeahead suggestions 306 are determined by the language model 150 described in FIG. 1, for instance, to be low-quality typeahead suggestions. The low-quality typeahead suggestions 306 are URL suggestions when the search intent was related to the Company Name 1.

In example 310, the partial search query 312 is “machine,” results in the set of typeahead suggestions 314. In example 310, the user has experience with machine learning by virtue of the user's profile data. Each of the typeahead suggestions 314 are evaluated using the systems and methods described herein. As shown in example 310, at least the two typeahead suggestions 316 are autocompleted typeahead suggestions determined by the language model 150 described in FIG. 1, for instance, to be high-quality typeahead suggestions. The high-quality typeahead suggestions 316 are autocompleted search suggestions that are semantically relevant and meaningful based on the user's profile. Accordingly, the user is likely to click on a typeahead suggestion to initiate a search given the user's interest in machine learning.

In example 320, the partial search query 322 is “mac,” which causes the set of typeahead suggestions 324. In example 320, the searcher user is a machine learning manager by virtue of the searcher user's profile data and/or traversing the entity graph and/or knowledge graph associated with the searcher user profile. Each of the typeahead suggestions 324 are evaluated using the systems and methods described herein. As shown in example 320, at least the one typeahead suggestion 326 is determined by the language model 150 described in FIG. 1, for instance, to be a high-quality typeahead suggestion. The typeahead suggestion is a name of a person who has experience in machine learning (e.g., JobTitle1). Such information is obtained, for example, by virtue of the searched user's profile data and/or traversing the entity graph and/or knowledge graph associated with the searched user profile.

While the partial search query 322 shares the first three characters as the partial search query 312, the typeahead suggestions 314 and 324 are different based on the searcher user intent, predicted using the searcher user's profile information. Additionally, the language model evaluates the typeahead search results differently based on evaluation instructions, described in FIG. 4.

FIG. 4 is an example of a prompt to instruct a machine learning model to evaluate typeahead suggestions, in accordance with some embodiments of the present disclosure.

As described herein, a language model uses a prompt to perform a task. The prompt 400 is an example of a prompt template generated using prompt engineering to instruct a language model to evaluate one or more typeahead suggestions, where the typeahead suggestion can be any type of multiple types of typeahead suggestions including an autocompleted search suggestion or a suggested search result such as an entity suggested search result, a product suggested search result, or a knowledge suggested search result. The prompt 400 explicitly instructs a machine learning model what to do and how to do it, while still providing the machine learning model the flexibility to generate the instructed content.

The prompt 400 includes a perspective portion 402 that defines the perspective of the language model. For example, the perspective portion 402 states that the language model is an evaluator whose role is to evaluate suggestions. Prompt 400 evaluates the typeahead suggestion types using one or more evaluation instructions 412-416. The diverse range of user search intent can be evaluated using a diverse set of evaluation instructions. For example, for suggested search results, the evaluation instruction instructs the language model to evaluate the quality of the result page and the relevance. In contrast, for search suggestions, the evaluation instruction instructs the language model to evaluate the autocompleted search query and the relevance of the autocompleted search query.

Specifically, evaluation instructions 412-414 instruct a language model how to evaluate a typeahead suggestion based on a simulated search intent and/or different types of typeahead suggestions. For example, to evaluate an autocompleted search suggestion, prompt 400 can include evaluation instruction 412. Evaluation instruction 412 instructs the language model to assume the typeahead suggestion is used to autocomplete a partial search query input given a user's profile information. To evaluate an entity suggested search result, prompt 400 can include evaluation instruction 414. Evaluation instruction 414 instructs the language model to assume the typeahead suggestion is a suggested search result used responsive to an entity search (e.g., a first type of suggested search result). To evaluate a product suggested search result, prompt 400 can include evaluation instruction 416. Evaluation instruction 416 instructs the language model to assume the typeahead suggestion is a suggested search result used responsive to a product search (e.g., a second type of suggested search result). Evaluation instructions 412-416 are illustrated in a single prompt 400, however in some embodiments, a single prompt 400 includes a single evaluation instruction.

The guideline portion 404 provides more specific instructions to the language model. For example, an “input format” portion of the guideline portion 404 prepares the language model for the types of inputs it will receive. For example, the language model receives the partial search query as an input. The language model also receives information about the user searcher obtained from the searcher user profile information. The language model also receives one or more typeahead suggestions determined using a typeahead suggestion engine. In some implementations, the typeahead suggestion is an autocompleted suggestion of the partial search query. In other implementations, the typeahead suggestion is a suggested search result that directs a user to a search page. If the typeahead suggestion is a suggested search result (as opposed to an autocompleted suggestion), then the language model also receives information about the suggested search result. For example, the language model can receive a summary of the information on the suggested search result page, a URL to the suggested search result page, or some combination. In some embodiments, the summary of the information on the suggested search result page is obtained by traversing an entity graph and/or knowledge graph. In some embodiments, a different machine learning model (such as a second language model) determines a text summary of the suggested search result page by crawling a web page and providing the text summary to the language model.

The “output format” portion of the guideline portion instructs the language model how to score each suggestion included in the initialization portion 408. Additionally, the language model is instructed to explain the reasoning behind the relevance score. The language model scores each typeahead suggestion using a binary rating. For example, the language model can determine whether a typeahead suggestion is a low-quality typeahead suggestion or a high-quality typeahead suggestion. As an example, a low-quality typeahead suggestion is a suggestion that is spammy, not safe for work, and/or does not make sense (e.g., irrelevant) relative to the partial search query. A high-quality typeahead suggestion is any suggestion that is not a low-quality typeahead suggestion. In other implementations, the language model can rate each typeahead suggestion. For example, the language model can use normalized discounted cumulative gain (NDCG) to rank the relevance of each typeahead suggestion. Other scoring mechanisms can be used to rank the quality of typeahead suggestions. In yet other implementations, a rating scale is predefined and the language model rates each typeahead suggestion using the rating scale. For example, a “2” represents a high-quality suggestion which should be the first result of a set of suggestions, a “1” represents a medium-quality suggestion such as a partially relevant and/or irrelevant suggestion, and a “0” represents a low-quality suggestion that should not have been suggested.

The searcher portion 406 includes information about the user inputting the partial search query. This information can be obtained (e.g., via prompt generator 104 of FIG. 1) using searcher profile information. As described herein, a user profile can be selected from a test data set. The input (shown in the initialization portion 408) is a previous search query associated with the selected searcher profile.

The initialization portion 408 provides the typeahead suggestions to be evaluated and the partial search query to the language model. For example, the partial search query is the input “Alex.” As described herein, the partial search query can be a subset of characters of a complete search query associated with the user profile and stored in test data.

The prompt in example 400 is a batch prompt because it includes multiple suggestions (e.g., suggestion 1 and suggestion 2) associated with a single user and a single search query. In other words, a single prompt includes multiple batch typeahead suggestions. Each typeahead suggestion is evaluated using the single prompt such that the output of the language model is an evaluation of multiple typeahead suggestions. In some embodiments, the prompt 400 is passed to a language model (such as language model 150 described in FIG. 1) using an Application Programming Interface (API) call. An API refers to an interface or communication protocol in a predefined format between a client and a server, for instance. In response to receiving an API call, an action is initiated and generally a response is communicated. For example, the prompt generator 104 generating the batch prompt uses an API call to communicate the single batch prompt (including multiple suggestions associated with a single user and a single search query) to the language model for evaluation. Responsive to receiving the API call with the batch prompt, the language model evaluates the quality of each typeahead suggestion in the batch prompt and communicates an API response with evaluations for each typeahead suggestion to the score evaluator 152 described in FIG. 1, for instance.

In other embodiments, the prompt includes a single suggestion (e.g., suggestion 1) associated with a single user and a single search query. In other words, a single prompt includes a single typeahead suggestion, and the output of the language model is an evaluation of the single typeahead suggestion. The initialization portion 408 also includes a suffix portion, which reinforces the information in the guideline portion 404. In some embodiments, the suffix portion is not included in a prompt 400.

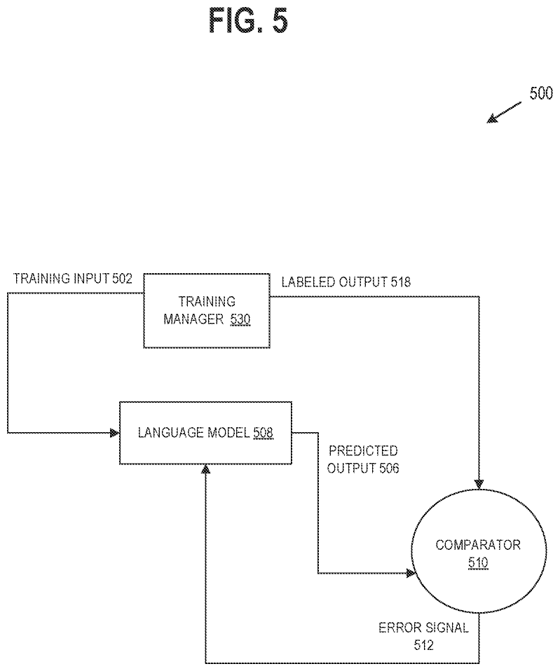

FIG. 5 is a flow diagram of an example method for fine-tuning a language model using supervised learning, in accordance with some embodiments of the present disclosure.

Supervised learning is a method of training (or fine-tuning) a machine learning model given input-output pairs. An input-output pair (e.g., training input 502 and corresponding actual output 518) is an input with an associated known output (e.g., an expected output, a labeled output, a ground truth). An actual output 518 may be a typeahead evaluation (e.g., a score) associated with a training input 502 including a partial search query, a typeahead suggestion, and context data (profile data 242, activity data 244, entity graph 246 data, and/or knowledge graph 248 data described in FIG. 2). The partial search query, typeahead suggestion, and context data of the training input 502 is provided to the language model 508 as a prompt.

In some embodiments, the training input 502 can include session information (e.g., whether the search session associated with the partial search query was abandoned, bypassed, or successful) and/or downstream interaction information (e.g., an indication of whether the user clicked on landing page results or other content items associated with the partial search query, an indication of whether the user clicked on another user profile, an indication of whether the user sent a message to another user). In yet other embodiments, the training input 502 can include examples of previous partial search queries and corresponding evaluation scores with evaluation reasonings. In these embodiments, the training input 502 is a few-shot prompt. In some implementations, the evaluations scores and evaluation reasonings are manually determined. In other implementations, the evaluation scores and evaluation reasoning are determined using a different language model. For example, GPT-4 is a first language model that can be executed to generate evaluation scores and evaluation reasonings associated with a partial search query and corresponding user information. The generated evaluation scores and evaluation reasonings can be used as part of training input 502 to fine-tune a smaller language model. In this manner, the language model 508 can be an architecturally smaller language model, as compared to GPT-4, but evaluate the quality of typeahead suggestions similarly to the evaluation of typeahead suggestions performed by GPT-4.

The training input 502 is a prompt used to train (or fine-tune) the language model 508 how to evaluate typeahead suggestions. For example, given a partial search query and context information, the language model 508 can determine an evaluation score and provide reasoning for the evaluation score.

The language model 508 can be any sequence-to-sequence machine learning model. For example, the language model 508 can include an instance of a text-based encoder-decoder model that accepts a string as an input (e.g., a partial search query as part of the training input 502) and outputs a string (e.g., an evaluation score with reasoning).

A layer may refer to a sub-structure of the language model 508 that includes a number of nodes (e.g., neurons) that perform a particular computation and are interconnected to nodes of adjacent layers. Nodes in each of the layers sum up values from adjacent nodes and apply an activation function, allowing the layers to detect nonlinear patterns. Nodes are interconnected by weights, which are adjusted based on an error during a training phase. The adjustment of the weights during training facilitates the language model 508 ability to generate an evaluation score and reasoning for the evaluation score.

The language model 508 includes one or more self-attention layers that are used to attend (e.g., assign weight values) to portions of the model input. Alternatively, or in addition, the language model 508 includes one or more feed-forward layers and residual connections that allow the language model 508 to machine-learn complex data patterns including relationships between different portions of the model input in multiple different contexts.

In example 500, the training manager 530 provides a prompt including the training input 502 to the language model 508. The language model 508 predicts output 506 by applying nodes in one or more layers of the language model 508 to the training input 502. The nodes of the language model 508 are adjusted based on an error determined by comparing the actual output 518 to the predicted output 506. The adjustment of the weights during training facilitates the language model's 508 ability to learn how to evaluate a partial search query and typeahead suggestion similar to examples of evaluated typeahead suggestions provided in the prompt.

In some embodiments, the comparator 510 compares the predicted output 506 (e.g., a predicted evaluation score) to the actual output 518 (e.g., a labeled evaluation score) to determine an amount of error or difference between the predicted output 506 and the actual output 518. The error (represented by error signal 512) is determined by comparing the predicted output 506 (e.g., a predicted evaluation score such as a binary value and/or a score according to a ranking algorithm) to the actual output 518 (e.g., the actual binary value and/or score value according to the ranking algorithm) using the comparator 510.

In some embodiments, the comparator 510 evaluates the predicted output 506 (e.g., an evaluation reasoning) using any natural language processing evaluation metric. For example, the comparator 510 can evaluate the evaluation reasoning by calculating a recall-oriented understudy for Gisting Evaluation (ROUGE) score. The ROUGE score is a metric for evaluating the predicted evaluation reasoning (e.g., predicted output 506) with respect to the labeled evaluation reasoning (e.g., actual output 518). Determining the error signal 512 using the ROUGE score involves calculating, by the comparator 510, a recall score and a precision score. The recall score is an indication of how much of the labeled evaluation reasoning (e.g., the actual output 518) the predicted evaluation reasoning captures (e.g., the predicted output 506). For example, the recall score can be a ratio of the overlapping number of tokens between the predicted output 506 and the actual output 518, to the total number of tokens of the actual output 518. The precision score is an indication of the relevance of the predicted evaluation reasoning with respect to the actual evaluation reasoning. For example, the precision score can be a ratio of the overlapping number of tokens between the predicted output 506 and the actual output 518 to the total number of tokens of the predicted output 506. The precision score and/or recall score can be passed to the language model 508 as error signal 512.

In some implementations, at least two error signals 512 are passed to the language model 508 (e.g., a first error signal based on the comparison of a predicted evaluation score to the actual evaluation score and a second error signal based on the comparison of the predicted evaluation reasoning to the actual evaluation reasoning). In other implementations, the error associated with the predicted evaluation score and actual evaluation score, and the error associated with the predicted evaluation reasoning and the actual evaluation reasoning are aggregated and a single error signal 512 is passed to the language model 508.

The error signal 512 is used to adjust the weights in the language model 508 such that after a set of training iterations, the language model 508 iteratively converges, e.g., changes (or learns) over time to generate an acceptably accurate (e.g., accuracy satisfies a defined tolerance or confidence level) predicted output 506 using the input-output pairs.

The language model 508 may be trained using a backpropagation algorithm, for instance. The backpropagation algorithm operates by propagating the error signal 512 through each of the algorithmic weights of the language model 508 such that the algorithmic weights adapt based on the amount of error. The error signal 512 may be calculated at each iteration (e.g., each pair of training inputs 502 and associated actual outputs 518), batch, and/or epoch.

The weighting coefficients of the language model 508 may be tuned to reduce the amount of error thereby minimizing the differences between (or otherwise converging) the predicted output 506 and the actual output 518. The language model 508 may be trained until the error determined at the comparator 510 is within a certain threshold (or a threshold number of batches, epochs, or iterations have been reached). In this manner, the language model 508 is trained to evaluate typeahead suggestions that mimic how a human would evaluate typeahead suggestions. The value of the weights is stored such that the trained (or fine-tuned) language model 508 can be deployed during inference time.

FIG. 6 is a block diagram of a computing system that includes a typeahead suggestion evaluator, in accordance with some embodiments of the present disclosure.

In the embodiment of FIG. 6, a computing system 600 includes one or more user systems 610, a network 620, an application software system 630, a typeahead suggestion evaluator 650, a data storage system 652, and an event logging service 670. All or at least some components of the typeahead suggestion evaluator 650 are implemented at the user system 610, in some implementations. For example, the typeahead suggestion evaluator 650 can be implemented directly upon a single client device without the need to communicate with, e.g., one or more servers over the Internet. Dashed lines are used in FIG. 6 to indicate that all or portions of the typeahead suggestion evaluator 650 can be implemented directly on the user system 610, e.g., the user's client device and/or the application software system 630.

A user system 610 includes at least one computing device, such as a personal computing device, a server, a mobile computing device, or a smart appliance, and at least one software application that the at least one computing device is capable of executing, such as an operating system or a front end of an online system. A typical user of user system 610 can be an administrator (such as the user using user system 110 described in FIG. 1) or end user of application software system 630 (such as the user using user system 210 described in FIG. 2).

Many different user systems 610 can be connected to network 620 at the same time or at different times. Different user systems 610 can contain similar components as described in connection with the illustrated user system 610. For example, many different end users of computing system 600 can be interacting with many different instances of application software system 630 through their respective user systems 610, at the same time or at different times.

User system 610 includes a user interface 612. User interface 612 is installed on or accessible to user system 610 by network 620. The user interface 612 can include, for example, a graphical display screen that includes graphical user interface elements such as at least one input box or other input mechanism and at least one slot. A slot as used herein refers to a space on a graphical display such as a web page or mobile device screen, into which digital content such as message suggestions and messages can be loaded for display to the user. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, a slot may be defined using a three-dimensional coordinate system.

User interface 612 can be used to input data such as a search query and receive content such as digital content items, typeahead suggestions, and/or landing page results. In some implementations, user interface 612 enables the user to upload, download, receive, send, or share of other types of digital content items, including posts, articles, comments, and shares, to initiate user interface events, and to view or otherwise perceive output such as data and/or digital content produced by application software system 630. For example, user interface 612 can include a graphical user interface (GUI), a conversational voice/speech interface, a virtual reality, augmented reality, or mixed reality interface, and/or a haptic interface. User interface 612 includes a mechanism for logging in to application software system 630, clicking or tapping on GUI user input control elements, interacting with typeahead suggestions or other search results, and displaying digital content items. Examples of user interface 612 include web browsers, command line interfaces, and mobile app front ends. User interface 612 as used herein can include application programming interfaces (APIs).

Network 620 includes an electronic communications network. Network 620 can be implemented on any medium or mechanism that provides for the exchange of digital data, signals, and/or instructions between the various components of computing system 600. Examples of network 620 include, without limitation, a Local Area Network (LAN), a Wide Area Network (WAN), an Ethernet network or the Internet, or at least one terrestrial, satellite or wireless link, or a combination of any number of different networks and/or communication links.

Application software system 630 includes any type of application software system that provides or enables the creation, upload, display, and/or distribution of at least one form of digital content, including user profiles, articles, comments, and videos between or among user systems, such as user system 610, through user interface 612. In some implementations, portions of the typeahead suggestion evaluator 650 are components of application software system 630. Components of application software system 630 can include an entity graph 632 and/or knowledge graph 634, a user connection network 636, and a training manager 664.

In the example of FIG. 6, application software system 630 includes an entity graph 632 and/or a knowledge graph 634. Entity graph 632 and/or knowledge graph 634 include data organized according to graph-based data structures that can be traversed via queries and/or indexes to determine relationships between entities. An example of an entity graph is shown in FIG. 7, described herein. For example, as described in more detail with reference to FIG. 7, entity graph 632 and/or knowledge graph 634 can be used to compute various types of affinity scores, similarity measurements, and/or statistics between, among, or relating to entities. Such information can be included as contextual information in a prompt passed to the typeahead suggestion evaluator 650 (and in particular, the language model 640).

Entity graph 632, 634 includes a graph-based representation of data stored in data storage system 652, described herein. For example, entity graph 632, 634 represents entities, such as users, organizations, and content items, such as posts, articles, comments, and shares, as nodes of a graph. Entity graph 632, 634 represents relationships, also referred to as mappings or links, between or among entities as edges, or combinations of edges, between the nodes of the graph. In some implementations, mappings between different pieces of data used by application software system 630 are represented by one or more entity graphs. In some implementations, the edges, mappings, or links indicate online interactions or activities relating to the entities connected by the edges, mappings, or links. For example, if a prospective recipient accepts a message from a sender, an edge may be created connecting the sender entity with the recipient entity in the entity graph, where the edge may be tagged with a label such as “message accepted.”

Portions of entity graph 632, 634 can be automatically re-generated or updated from time to time based on changes and updates to the stored data, e.g., updates to entity data and/or activity data. Also, entity graph 632, 634 can refer to an entire system-wide entity graph or to only a portion of a system-wide graph. For instance, entity graph 632, 634 can refer to a subset of a system-wide graph, where the subset pertains to a particular user or group of users of application software system 630.

In some implementations, knowledge graph 634 is a subset or a superset of entity graph 632. For example, in some implementations, knowledge graph 634 includes multiple different entity graphs 632 that are joined by edges. For instance, knowledge graph 634 can join entity graphs 632 that have been created across multiple different databases or across different software products. In some implementations, knowledge graph 634 includes a platform that extracts and stores different concepts that can be used to establish links between data across multiple different software applications. Examples of concepts include topics, industries, and skills.

Knowledge graph 634 includes a graph-based representation of data stored in data storage system 652, described herein. Knowledge graph 634 represents relationships, also referred to as links or mappings, between entities or concepts as edges, or combinations of edges, between the nodes of the graph. In some implementations, mappings between different pieces of data used by application software system 630 or across multiple different application software systems are represented by the knowledge graph 634.

User connection network 636 includes, for instance, a social network service, professional social network software and/or other social graph-based applications. Application software system 630 can include online systems that provide social network services, general-purpose search engines, specific-purpose search engines, messaging systems, content distribution platforms, e-commerce software, enterprise software, or any combination of any of the foregoing or other types of software. For example, one or more search engines of the user connection network 636 calls the typeahead suggestion evaluator 650 to verify the typeahead suggestions displayed to a user (e.g., via user system 610).

A front-end portion of application software system 630 can operate in user system 610, for example as a plugin or widget in a graphical user interface of a web application, mobile software application, or as a web browser executing user interface 612. In an embodiment, a mobile app or a web browser of a user system 610 can transmit a network communication such as an HTTP (HyperText Transfer Protocol) request over network 620 in response to user input that is received through a user interface provided by the web application, mobile app, or web browser, such as user interface 612. A request is formulated, e.g., by a browser or mobile app at a user device, in connection with a user interface event such as a login, click on a graphical user interface element, or a page load. The request includes, for example, a network message such as an HTTP request for a transfer of data from an application front end to the application's back end, or from the application's back end to the front end, or, more generally, a request for a transfer of data between two different devices or systems, such as data transfers between servers and user systems. In some embodiments, the typeahead suggestion evaluator 650 verifies typeahead suggestions determined using a typeahead engine (e.g., executed by the application software system 630).

In the example of FIG. 6, the application software system 630 includes a training manager 664. In other examples, the training manager 664 is included as part of the typeahead suggestion evaluator 650. The training manager 664 can train or fine-tune one or more machine learning models. For example, the training manager 664 can fine-tune a language model to evaluate typeahead suggestions using supervised learning, as described in FIG. 5.

The typeahead suggestion evaluator 650 is used to evaluate the quality of typeahead suggestions. In the example of FIG. 6, the typeahead suggestion evaluator 650 includes a typeahead engine generator 622, a prompt generator 604, a language model 640, and a score evaluator 638.

The typeahead engine generator 622 can determine any one or more typeahead suggestions using any one or more typeahead suggestion techniques. Example typeahead suggestion techniques described herein include embedding based retrieval, deploying a language model, and/or traversing nodes of a graph structure. The typeahead engine generator 622 can be deployed as the typehead engine control 120 and/or the typeahead engine test 122 described in FIG. 1. During an online implementation, a single typeahead engine generator 622 is deployed to suggest typeahead suggestions. During an offline typeahead suggestion, multiple typeahead engines can be deployed and the typeahead suggestions determined by each of the multiple typeahead engines are compared.

The prompt generator 604 creates a prompt including information such as one or more typeahead suggestions, one or more evaluation instructions, user profile information, context information (e.g., information about the typeahead suggestion such as a summary of content related to the typeahead suggestion, or a URL), downstream information (e.g., information about whether the user clicked on the typeahead suggestion, information about whether the user clicked on content associated with the typeahead suggestion). The prompt instructs a language model to evaluate different types of typeahead suggestions with respect to a partial search query by including one or more evaluation instructions. Accordingly, the language model 640 is instructed to evaluate typeahead suggestions using one or more evaluation instructions based on whether the typeahead suggestion could be a suggested search result (such as an entity suggested search result, a product suggested search result, a job entity suggested search result, or a knowledge suggested search result (e.g., a skill query knowledge suggested search result, a topic query knowledge suggested search result, or a question query knowledge suggested search result) and/or an autocompleted search suggestion. To evaluate the quality of the typeahead suggestion, the language model 640 assumes a particular user by simulating a user intent using user information. Accordingly, the prompt instructs the language model how to evaluate the quality of the typeahead suggestion given a user identity, where a typeahead suggestion receiving a high-quality determination is a personalized and relevant typeahead suggestion with respect to the user identity.

The language model 640 evaluates the quality of typeahead suggestions using the prompt. The quality of the typeahead suggestions can be a binary evaluation (e.g., high-quality or low-quality) or a scaled quality ranking that, for example, evaluates the typeahead quality with respect to the position of the typeahead suggestion in a set of typeahead suggestions. An example scaled quality ranking algorithm is the NDCG algorithm, which scores the typeahead suggestion according to a scale of 0-5, for instance. The language model 640 evaluates each typeahead suggestion by scoring the typeahead suggestion and providing a reasoning for the score.

The score evaluator 638 compares multiple typeahead evaluations to determine which, of multiple typeahead engines, determined more high-quality typeahead suggestions. For example, the score evaluator 638 can average typeahead suggestion scores (e.g., quality rankings) and compare the average typeahead suggestion scores associated with each of multiple typeahead engines to determine the typeahead engine that provided more high-quality typeahead engine suggestions.

Event logging service 670 captures and records network activity data generated during operation of application software system 630, including user interface events generated at user systems 610 via user interface 612, in real time, and formulates the user interface events into a data stream that can be consumed by, for example, a stream processing system. Examples of network activity data include clicks on typeahead suggestions, executed searches, clicks on digital content, and social action data such as likes, shares, comments. For instance, when a user of application software system 630 via a user system 610 clicks on a user interface element, such as a typeahead suggestion, or a user interface control element such as a view, comment, share, or uploads a file, or creates a message, loads a web page, or scrolls through a feed, etc., event logging service 670 fires an event to capture an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web or mobile.

Data storage system 652 includes data stores and/or data services that store digital data received, used, manipulated, and produced by application software system 630 and/or typeahead suggestion evaluator 650, including a typeahead engine store 654, a test data store 656, and a prompt store 658.

The typeahead engine store 654 stores one or more benchmark typeahead engines (e.g., other versions of typeahead engine generator 622). Such typeahead engines, such as typeahead engine generator 622, may be used by the application software system 630 to suggest typeaheads responsive to a received partial search query. The benchmark typeahead engines are compared to new (or modified, experimental) typeahead engines to determine whether the new typeahead engine is an improvement over the benchmark typeahead engine (e.g., as described in FIG. 1). In response to the new typeahead engine outperforming a benchmark typeahead engine (e.g., based on the new typeahead engine suggesting more high-quality typeahead suggestions than the stored typeahead engine), the new typeahead engine becomes stored as a benchmark typeahead engine such that additional improvements can be made to future typeahead engines. In some embodiments, the typeahead engine store 654 stores previous typeahead suggestions and corresponding search queries.

The test data store 656 stores test data. Test data can include a partial search query and context data (profile data 242, activity data 244, entity graph 246 data, and/or knowledge graph 248 data described in FIG. 2). In some embodiments, search queries and user information are stored as test data based on randomly sampled search queries (and corresponding user information) and/or randomly sampling user information (and corresponding search queries).

In other embodiments, the test data includes specifically selected search queries and/or user information to be used to evaluate the quality of typeahead suggestions. For example, specific users can be selected for test data (and corresponding search queries associated with the specific users). For instance, users are selected for test data that have access and/or updated their user profile within the last week, last month, etc.

In other embodiments, the test data includes specifically selected search queries (and corresponding user information) based on search session information associated with the search query. For example, the test data can include pairs of search queries and user information according to a distribution of abandoned search sessions, bypassed search sessions, and successful search sessions.

In other embodiments, the test data includes specifically selected search queries (and corresponding user information) based on search queries tagged with types of typeahead suggestions. For example, a successful search session means that a user has clicked on a typeahead suggestion. The clicked-on typeahead suggestion can used to tag the corresponding search query. For example, search queries can be tagged with “entity suggested search result,” “job entity search suggested result,” “product suggested search result,” skill query knowledge suggested search result,” “topic query knowledge suggested search result,” and “question query knowledge suggested search result.” Accordingly, the test data can include pairs of search queries and user information according to a distribution of types of typeahead suggestions based on tagged types of typeahead suggestions.

The prompt store 658 stores prompts. As described herein, the prompt generator 604 generates prompts using one or more typeahead suggestions (e.g., determined via typeahead engine generator 622), partial search queries, and user information. However, because of a diverse range of user search intent (e.g., searches for products, searches for knowledge, searches for entities, requests for autocompleted search queries), there should be a diverse set of evaluation instructions.

In some embodiments, the prompt store 658 stores prompts including a single evaluation instruction. For example, a single prompt evaluates a single typeahead suggestion with respect to a single suggested search result type using a partial search query and user information. For instance, a prompt instructs a language model to evaluate whether the typeahead suggestion is appropriate for an entity search based on a provided partial search query and user information. In some embodiments, the prompt store 658 stores prompts including multiple evaluation instructions. For example, a single prompt evaluates a single typeahead suggestion with respect to multiple suggestion search result types using a partial search query and user information. For instance, a prompt instructs a language model to evaluate whether the typeahead suggestion is appropriate for an entity search based on the provided partial search query and user information. The same prompt also instructs the language model to evaluate whether the typeahead suggestion is appropriate for a product search based on the provided partial search query and user information.

In some embodiments, the prompt store 658 stores prompts that instruct a language model to evaluate multiple typeahead suggestions using one or more evaluation instructions. Such prompts are considered batch prompts. For example, a prompt instructs a language model to evaluate whether multiple typeahead suggestions are appropriate for an entity search based on a provided partial search query and user information. Accordingly, a single prompt can include a single evaluation instruction to evaluate multiple typeahead suggestions. Additionally, or alternatively, a prompt instructs a language model to evaluate whether multiple typeahead suggestions are appropriate for an entity search based on the provided partial search query and user information. The same prompt also instructs the language model to evaluate whether the multiple typeahead suggestions are appropriate for a product search based on the provided partial search query and user information. Accordingly, a single prompt can include multiple evaluation instructions to evaluate multiple typeahead suggestions.

In some embodiments, the data storage system 652 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of the data storage system 652 can be configured to store data produced in real-time and/or offline (e.g., batch) data processing. A data store configured for real-time data processing can be referred to as a real-time data store. A data store configured for offline or batch data processing can be referred to as an offline data store. Data stores can be implemented using databases, such as key: value stores, relational databases, and/or graph databases. Data can be written to and read from data stores using query technologies, e.g., SQL or NoSQL.

A key: value database, or key: value store, is a nonrelational database that organizes and stores data records as key: value pairs. The key uniquely identifies the data record, i.e., the value associated with the key. The value associated with a given key can be, e.g., a single data value, a list of data values, or another key: value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

The data storage system 652 resides on at least one persistent and/or volatile storage device that can reside within the same local network as at least one other device of computing system 600 and/or in a network that is remote relative to at least one other device of computing system 600. Thus, although depicted as being included in computing system 600, portions of data storage system 652 can be part of computing system 600 or accessed by computing system 600 over a network, such as network 620.

While not specifically shown, it should be understood that any of user system 610, application software system 630, typeahead suggestion evaluator 650, data storage system 652, and event logging service 670 includes an interface embodied as computer programming code stored in computer memory that when executed causes a computing device to enable bidirectional communication with any other of user system 610, application software system 630, typeahead suggestion evaluator 650, data storage system 652, or event logging service 670 using a communicative coupling mechanism. Examples of communicative coupling mechanisms include network interfaces, inter-process communication (IPC) interfaces and application program interfaces (APIs).

Each of user system 610, application software system 630, typeahead suggestion evaluator 650, data storage system 652, and event logging service 670 is implemented using at least one computing device that is communicatively coupled to electronic communications network 620. Any of user system 610, application software system 630, typeahead suggestion evaluator 650, data storage system 652, and event logging service 670 can be bidirectionally communicatively coupled by network 620. User system 610 as well as other different user systems (not shown) can be bidirectionally communicatively coupled to application software system 630 and/or typeahead suggestion evaluator 650.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 610, application software system 630, typeahead suggestion evaluator 650, data storage system 652, and event logging service 670 are implemented using computer software, hardware, or software and hardware, and can include combinations of automated functionality, data structures, and digital data, which are represented schematically in the figures. User system 610, application software system 630, typeahead suggestion evaluator 650, data storage system 652, and event logging service 670 are shown as separate elements in FIG. 6 for ease of discussion but, except as otherwise described, the illustration is not meant to imply that separation of these elements is required. The illustrated systems, services, and data stores (or their functionality) of each of user system 610, application software system 630, typeahead suggestion evaluator 650, data storage system 652, and event logging service 670 can be divided over any number of physical systems, including a single physical computer system, and can communicate with each other in any appropriate manner.

FIG. 7 is an example of an entity graph, in accordance with some embodiments of the present disclosure.

The entity graph 700 can be used by an application software system, e.g., to support a user connection network, in accordance with some embodiments of the present disclosure. The entity graph 700 can be used (e.g., queried or traversed) to obtain user information, which is associated with search query 107 of FIG. 1 or partial search query 206 of FIG. 2. The user information broadly includes profile data 242, activity data 244, content items 260 and relationships (determined using entity graph 246 and/or knowledge graph 248) described in FIG. 2. The user information is included as part of a prompt and passed to a language model (e.g., language model 150 described in FIG. 1, and/or language model 250 described in FIG. 2) such that the language model can predict a user intent (as described in the online implementation of the language model 250 in FIG. 2) or simulate a user intent (as described in the offline implementation of the language model 150 in FIG. 1). The user intent is used to evaluate the quality of typeahead suggestion(s) associated with the partial search query such that the evaluated typeahead suggestion is personalized based on the user intent. For example, a typeahead suggestion may be high-quality given a first user intent, whereas the same typeahead suggestion may be low-quality given a second user intent. In some embodiments, the user intent and the entity graph 700 can be used to generate typeahead suggestions based on partial search queries.

An entity graph includes nodes, edges, and data (such as labels, weights, or scores) associated with nodes and/or edges. Nodes can be weighted based on, for example, edge counts or other types of computations, and edges can be weighted based on, for example, affinities, relationships, activities, similarities, or commonalities between the nodes connected by the edges, such as common attribute values (e.g., two users have the same job title or employer, or two users are n-degree connections in a user connection network).

A graphing mechanism is used to create, update and maintain the entity graph. In some implementations, the graphing mechanism is a component of the database architecture used to implement the entity graph 700. For instance, the graphing mechanism can be a component of data storage system 752 and/or application software system 730, shown in FIG. 7, and the entity graphs created by the graphing mechanism can be stored in one or more data stores of data storage system 752.

The entity graph 700 is dynamic (e.g., continuously updated) in that it is updated in response to occurrences of interactions between entities in an online system (e.g., a user connection network) and/or computations of new relationships between or among nodes of the graph. These updates are accomplished by real-time data ingestion and storage technologies, or by offline data extraction, computation, and storage technologies, or a combination of real-time and offline technologies. For example, the entity graph 700 is updated in response to user updates of user profiles, user connections with other users, and user creations of new content items, such as messages, posts, articles, comments, and shares.

The entity graph 700 includes a knowledge graph that contains cross-application links. For example, message activity data obtained from a messaging system can be linked with entities of the entity graph.

In the example of FIG. 7, entity graph 700 includes entity nodes, which represent entities, such as content item nodes (e.g., Post U21, Article 1, Learning Video 1), user nodes (e.g., User 1, User 2, User 3, User 4), and job nodes (e.g., Job 1, Job 2). Entity graph 700 also includes attribute nodes, which represent attributes (e.g., job title data, article title data, skill data, topic data) of entities. Examples of attribute nodes include title nodes (e.g., Title U1, Title A1), company nodes (e.g., Company 1), topic nodes (Topic 1, Topic 2), and skill nodes (e.g., Skill A1, Skill U11, Skill U31, Skill U41).

Entity graph 700 also includes edges. The edges individually and/or collectively represent various different types of relationships between or among the nodes. Data can be linked with both nodes and edges. For example, when stored in a data store, each node is assigned a unique node identifier and each edge is assigned a unique edge identifier. The edge identifier can be, for example, a combination of the node identifiers of the nodes connected by the edge and a timestamp that indicates the date and time at which the edge was created. For instance, in the graph 700, edges between user nodes can represent online social connections between the users represented by the nodes, such as ‘friend’ or ‘follower’ connections between the connected nodes. As an example, in the entity graph 700, User 3 is a first-degree connection of User 1 by virtue of the CONNECTED edge between the User 3 node and the User 1 node, while User 2 is a second-degree connection of User 3, although User 1 has a different type of connection, FOLLOWS, with User 2 than with User 3.

In the entity graph 700, edges can represent activities involving the entities represented by the nodes connected by the edges. For example, a POSTED edge between the User 2 node and the Post U21 node indicates that the user represented by the User 2 node posted the digital content item represented by the PostU21 node to the application software system (e.g., as educational content posted to a user connection network). As another example, a SHARED edge between the User 1 node and the Post U21 node indicates that the user represented by the User 1 node shared the content item represented by the Post U21 node. Similarly, the CLICKED edge between the User 3 node and the Article 1 node indicates that the user represented by the User 3 node clicked on the article represented by the Article 1 node, and the LIKED edge between the User 3 node and the Comment U1 node indicates that the user represented by the User 3 node liked the content item represented by the Comment U1 node. As described herein, context information can be obtained using the entity graph 700 by traversing the nodes and edges of the entity graph 700. For example, given a user identifier associated with a particular user node (e.g., User 1), contextual information is obtained by traversing the edges of the User 1 node.

In some implementations, combinations of nodes and edges are used to compute various scores, and those scores are used by the prompt generator to, for example, generate prompts with contextual information. For example, a score that measures the affinity of the user represented by the User 1 node to the post represented by the Post U21 node can be computed using a path p1 that includes a sequence of edges between the nodes User 1 and Post U21 and/or a path p2 that includes a sequence of edges between the nodes User 1, Comment U1, and Post U21 and/or a path p3 that includes a sequence of edges between the nodes User 1, User 2, and Post U21 and/or a path p4 that includes a sequence of edges between the nodes User 1, User 3, Comment U1, Post U21. Any one or more of the paths p1, p2, p3, p4 and/or other paths through the graph 700 can be used to compute scores that represent affinities, relationships, or statistical correlations between different nodes. For instance, based on relative edge counts, a user-post affinity score computed between User U1 and Post U21, which might be predictive of the user's interest in the topic of the Post U21, might be higher than the user-post affinity score computed between User U4 and Post U21. Similarly, a user-skill affinity score computed between User 3 and Skill U31 might be higher than the user-skill affinity score computed between User 3 and Skill U11.

The examples shown in FIG. 7 and the accompanying description above are provided for illustration purposes. This disclosure is not limited to the described examples.

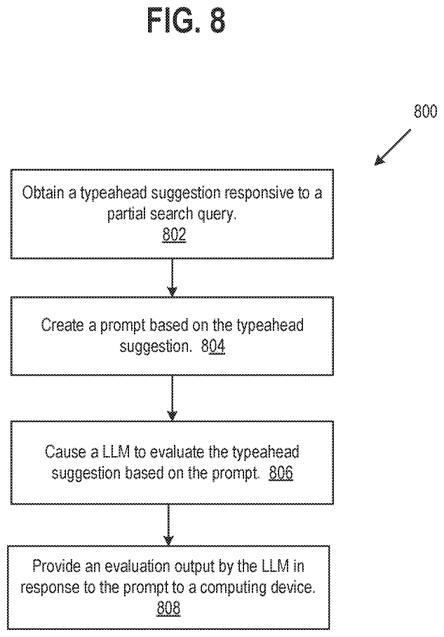

FIG. 8 is a flow diagram of an example method for evaluating typeahead suggestions, in accordance with some embodiments of the present disclosure.

The method 800 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, one or more portions of method 800 is performed by one or more components of the typeahead suggestion evaluator 650 or the application software system 630 of FIG. 6, or the typeahead suggestion evaluator 136 of FIG. 1 or the typeahead suggestion evaluator 236 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 802, a processing device obtains a typeahead suggestion responsive to a partial search query. For example, a typeahead engine determines a typeahead suggestion responsive to receiving one or more characters of a search query. The typeahead suggestion can be an autocompleted search suggestion or a suggested search result type such as an entity suggested search result, a product suggested search result, a job entity suggested search result, or a knowledge suggested search result.

At operation 804, the processing device creates a prompt based on the typeahead suggestion. The prompt further includes user profile information associated with a user profile and the partial search query. The prompt is used to instruct a language model such as a LLM how to evaluate the typeahead suggestion. Accordingly, the prompt includes one or more evaluation instructions. For example, the prompt includes an evaluation instruction for the autocompleted search suggestion, an evaluation instruction for the entity suggested search result, an evaluation instruction for the product suggested search result, an evaluation instruction for the job entity suggested search result, or an evaluation instruction for the knowledge suggested search result. In some implementations, the prompt is a batch prompt including multiple typeahead suggestions. As a result of the multiple typeahead suggestions in the prompt, a language model evaluates each of the typeahead suggestions for a single prompt.

At operation 806, the processing device causes a large language model to evaluate the typeahead suggestion based on the prompt. The evaluation of the typeahead suggestion includes a score, representing whether the typeahead suggestion is a high-quality typeahead suggestion or a low-quality typeahead suggestion based on the evaluation instruction and the user profile information. The score may be a binary value that maps to low-quality or high-quality typeahead suggestions. For example, a high-quality typeahead suggestion receives a score of “1” and a low-quality typeahead suggestion receives a score of “0.” The score may also be determined using a scaled rating system. For example, the large language model can evaluate the typeahead suggestion on a scale of 0-5. The evaluation of the typeahead suggestion also includes a reasoning for the score in natural language.

In some implementations, the large language model is a fine-tuned language model that is trained to evaluate typeahead suggestions using supervised learning. For example, the large language model is iteratively trained using a training input including a training prompt including a partial search query training input, a training user profile information associated with a training user profile, and/or a training typeahead suggestion. The corresponding training output includes a training evaluation output, which includes an evaluation score and a reason for the evaluation score. The training input is used as a prompt to train the large language model. In some implementations, the prompt used for training is a few-shot prompt that includes examples of typeahead suggestions and corresponding evaluation outputs. Accordingly, the training input can include a training evaluation output and a corresponding evaluation output, where the evaluation output includes an evaluation score and a reason for the evaluation score. In some implementations, the training prompt further comprises an indication of a downstream interaction (e.g., whether or not the user clicked on the typeahead suggestion, whether the user clicked on digital content associated with the typeahead suggestion).

In some implementations, the large language model used to evaluate the typeahead suggestion also generates the typeahead suggestion. For example, the large language model can generate a second typeahead suggestion, where the second typeahead suggestion is responsive to a partial search query. A second prompt is created that includes the second typeahead suggestion. The large language model can therefore evaluate the second typeahead suggestion based on the second prompt to obtain a second evaluation output.

In some implementations, the large language model is deployed in an offline implementation that compares typeahead suggestions of two typeahead engines. For example, the large language model can obtain a second typeahead suggestion determined using a second typeahead engine, where the second typeahead suggestion is responsive to the partial search query used to obtain the first typeahead suggestion. A second prompt is created based on the second typeahead suggestion such that the large language model can evaluate the second typeahead suggestion based on the second prompt to obtain a second evaluation output. The second evaluation output is compared to the evaluation output such that a decision can be made as to which typeahead engine performed better (based on the quality of the typeahead suggestions determined from each typeahead engine). Accordingly, the first typeahead engine or the second typeahead engine can be flagged based on the comparison of the second evaluation output with the evaluation output.

At operation 808, the processing device provides an evaluation output by the large language model in response to the prompt, to a computing device. The evaluation output can include a score and a reasoning for the score. The score can be a binary representation of whether the typeahead suggestion is a high-quality typeahead suggestion or a low-quality typeahead suggestion. Alternatively, the score can be a value in a scaled score rating (e.g., a value from 0-5).

In some implementations, typeahead suggestions are evaluated for pairs of search queries and user profile information included in a test data set. That is, a typeahead engine suggests typeahead suggestions for search queries included in a test data set, and the large language model evaluates the typeahead suggestions using the pairs of search queries and user profile information included in the test data set. In some implementations, the test data set includes a set of input pairs (e.g., search queries and user profile information) of a distribution of pairs of partial search queries and user profile information associated with abandoned search sessions, pairs of partial search queries and user profile information associated with bypassed search sessions, and pairs of partial search queries and user profile information associated with successful search sessions. In some implementations, the test data set includes a set of input pairs (e.g., search queries and user profile information) of a distribution of pairs of partial search queries and user profile information associated with autocompleted search suggestions, pairs of partial search queries and user profile information associated with entity suggested search results, pairs of partial search queries and user profile information associated with product suggested search results, pairs of partial search queries and user profile information associated with job entity suggested search results, and pairs of partial search queries and user profile information associated with knowledge suggested search results.

The typeahead suggestion is dependent on the user performing the search query. Accordingly, a first evaluation output can include an indication of a first typeahead suggestion being a low-quality typeahead suggestion based on a first user profile. A second typeahead suggestion can be obtained responsive to a second partial search query, where the second typeahead suggestion is the same as the first typeahead suggestion. A second prompt is created based on the second typeahead suggestion and a second user profile, where the second user profile (and associated user profile information) is different from the first user profile (and associated user profile information). The large language model can evaluate the second typeahead suggestion based on the second prompt to obtain a second evaluation output, where the second evaluation output indicates that the second typeahead suggestion is a high-quality typeahead suggestion. Accordingly, the typeahead suggestion and search query are the same, but the user profile is different, causing a difference in evaluation scores determined by the large language model.

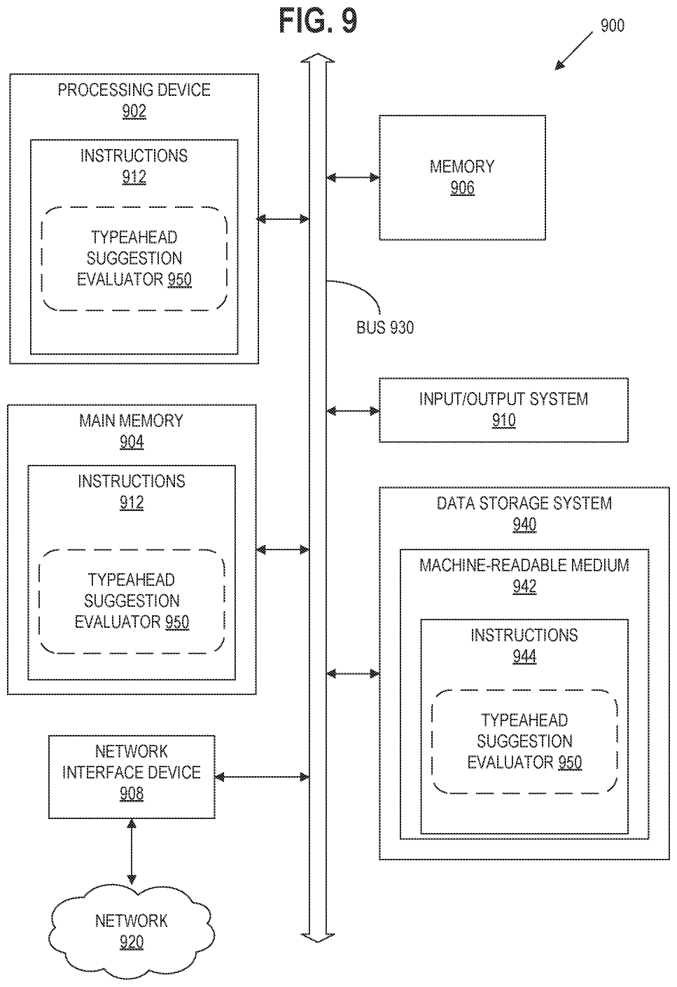

FIG. 9 is a block diagram of an example computer system including typeahead suggestion evaluator, in accordance with some embodiments of the present disclosure.

In FIG. 9, an example machine of a computer system 900 is shown, within which a set of instructions for causing the machine to perform any of the methodologies discussed herein can be executed. In some embodiments, the computer system 900 can correspond to a component of a networked computer system (e.g., as a component of the typeahead suggestion evaluator 136 of FIG. 1, the typeahead suggestion evaluator 236 of FIG. 2, or the application software system 630 of FIG. 6) that includes, is coupled to, or utilizes a machine to execute an operating system to perform operations corresponding to one or more components of the typeahead suggestion evaluator 136 of FIG. 1, the typeahead suggestion evaluator 236 of FIG. 2, or the application software system 630 of FIG. 6. For example, computer system 900 corresponds to a portion of computing system 600 when the computing system is executing a portion of the typeahead suggestion evaluator 136 of FIG. 1.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a memory 903 (e.g., flash memory, static random access memory (SRAM), etc.), an input/output system 910, and a data storage system 940, which communicate with each other via a bus 930.

Processing device 902 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be at least one special-purpose processing device such as an application specific integrated circuit (ASIC), a field programmable gate array (FPGA), a digital signal processor (DSP), network processor, or the like. The processing device 902 is configured to execute instructions 912 for performing the operations and steps discussed herein.

In some embodiments of FIG. 9, typeahead suggestion evaluator 950 represents portions of application software system 630 of FIG. 6 when the computer system 900 is executing those portions of typeahead suggestion evaluator 950. Instructions 912 include portions of typeahead suggestion evaluator 950 when those portions of the typeahead suggestion evaluator 950 are being executed by processing device 902. Thus, the typeahead suggestion evaluator 950 is shown in dashed lines as part of instructions 912 to illustrate that, at times, portions of the typeahead suggestion evaluator 950 are executed by processing device 902. For example, when at least some portion of the typeahead suggestion evaluator 950 is embodied in instructions to cause processing device 902 to perform the method(s) described herein, some of those instructions can be read into processing device 902 (e.g., into an internal cache or other memory) from main memory 904 and/or data storage system 940. However, it is not required that all of the typeahead suggestion evaluator 950 be included in instructions 912 at the same time and portions of the typeahead suggestion evaluator 950 are stored in at least one other component of computer system 900 at other times, e.g., when at least one portion of the typeahead suggestion evaluator 950 is not being executed by processing device 902.

The computer system 900 further includes a network interface device 908 to communicate over the network 920. Network interface device 908 provides a two-way data communication coupling to a network. For example, network interface device 908 can be an integrated-services digital network (ISDN) card, cable modem, satellite modem, or a modem to provide a data communication connection to a corresponding type of telephone line. As another example, network interface device 908 can be a local area network (LAN) card to provide a data communication connection to a compatible LAN. Wireless links can also be implemented. In any such implementation network interface device 908 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 900.

Computer system 900 can send messages and receive data, including program code, through the network(s) and network interface device 908. In the Internet example, a server can transmit a requested code for an application program through the Internet and network interface device 908. The received code can be executed by processing device 902 as it is received, and/or stored in data storage system 940, or other non-volatile storage for later execution.

The input/output system 910 includes an output device, such as a display, for example a liquid crystal display (LCD) or a touchscreen display, for displaying information to a computer user, or a speaker, a haptic device, or another form of output device. The input/output system 910 can include an input device, for example, alphanumeric keys and other keys configured for communicating information and command selections to processing device 902. An input device can, alternatively or in addition, include a cursor control, such as a mouse, a trackball, or cursor direction keys for communicating direction information and command selections to processing device 902 and for controlling cursor movement on a display. An input device can, alternatively or in addition, include a microphone, a sensor, or an array of sensors, for communicating sensed information to processing device 902. Sensed information can include voice commands, audio signals, geographic location information, haptic information, and/or digital imagery, for example.

The data storage system 940 includes a machine-readable storage medium 942 (also known as a computer-readable medium) on which is stored at least one set of instructions 944 or software embodying any of the methodologies or functions described herein. The instructions 944 can also reside, completely or at least partially, within the main memory 904 and/or within the processing device 902 during execution thereof by the computer system 900, the main memory 904 and the processing device 902 also constituting machine-readable storage media. In one embodiment, the instructions 944 include instructions to implement functionality corresponding to the application software system 630 of FIG. 6 (e.g., typeahead suggestion evaluator 136 of FIG. 1 typeahead suggestion evaluator 236 of FIG. 2).

Dashed lines are used in FIG. 9 to indicate that it is not required that the typeahead suggestion evaluator 950 be embodied entirely in instructions 912, 914, and 944 at the same time. In one example, portions of the typeahead suggestion evaluator 950 are embodied in instructions 914, which are read into main memory 904 as instructions 914, and portions of instructions 912 are read into processing device 902 as instructions 912 for execution. In another example, some portions of the typeahead suggestion evaluator 950 are embodied in instructions 944 while other portions are embodied in instructions 914 and still other portions are embodied in instructions 912.

While the machine-readable storage medium 942 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 9 and the accompanying description above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 600, can carry out the above-described computer-implemented methods in response to its processor executing a computer program (e.g., a sequence of instructions) contained in a memory or other non-transitory machine-readable storage medium (e.g., a non-transitory computer readable medium). Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
obtaining a typeahead suggestion responsive to a partial search query;
creating a prompt based on the typeahead suggestion;
causing a large language model (LLM) to evaluate the typeahead suggestion based on the prompt; and
providing, to a computing device, an evaluation output by the LLM in response to the prompt.

2. The method of claim 1, wherein the typeahead suggestion comprises an autocompleted search suggestion or at least one of an entity suggested search result, a product suggested search result, a job entity suggested search result, or a knowledge suggested search result.

3. The method of claim 2, wherein the prompt further comprises at least one of an evaluation instruction for the autocompleted search suggestion, an evaluation instruction for the entity suggested search result, an evaluation instruction for the product suggested search result, an evaluation instruction for the job entity suggested search result, or an evaluation instruction for the knowledge suggested search result.

4. The method of claim 1, wherein the prompt further comprises user profile information associated with a user profile and the partial search query.

5. The method of claim 4, wherein the evaluation output comprises an indication of the typeahead suggestion being a low-quality typeahead suggestion, further comprising:
obtaining a second typeahead suggestion responsive to a second partial search query, wherein the second typeahead suggestion is the same as the typeahead suggestion;
creating a second prompt based on the second typeahead suggestion and a second user profile information, wherein the second user profile information is different from the user profile information; and
causing the LLM to evaluate the second typeahead suggestion based on the second prompt to obtain a second evaluation output, wherein the second evaluation output comprises an indication of the second typeahead suggestion being a high-quality typeahead suggestion.

6. The method of claim 4, wherein the partial search query and the user profile information is an input pair of a set of input pairs.

7. The method of claim 6, wherein the set of input pairs comprises a distribution of pairs of partial search queries and user profile information associated with abandoned search sessions, pairs of partial search queries and user profile information associated with bypassed search sessions, and pairs of partial search queries and user profile information associated with successful search sessions.

8. The method of claim 6, wherein the set of input pairs comprises a distribution of pairs of partial search queries and user profile information associated with autocompleted search suggestions, pairs of partial search queries and user profile information associated with entity suggested search results, pairs of partial search queries and user profile information associated with product suggested search results, pairs of partial search queries and user profile information associated with job entity suggested search results, and pairs of partial search queries and user profile information associated with knowledge suggested search results.

9. The method of claim 1, wherein the typeahead suggestion is generated using a first model, further comprising:
generating a second typeahead suggestion using a second model, wherein the second typeahead suggestion is responsive to the partial search query;
creating a second prompt based on the second typeahead suggestion;
causing the LLM to evaluate the second typeahead suggestion based on the second prompt to obtain a second evaluation output;
comparing the second evaluation output with the evaluation output; and
flagging the first model or the second model based on the comparison of the second evaluation output with the evaluation output.

10. The method of claim 1, wherein the prompt comprises at least one of user activity or user profile information associated with the user profile, and wherein the typeahead suggestion is one typeahead suggestion of a plurality of typeahead suggestions, and wherein the LLM provides a plurality of evaluation outputs corresponding to the plurality of typeahead suggestions.

11. The method of claim 1, wherein the typeahead suggestion is determined using the LLM, further comprising:
generating a second typeahead suggestion determined using the LLM, wherein the second typeahead suggestion is responsive to the partial search query;
creating a second prompt based on the second typeahead suggestion; and
causing the LLM to evaluate the second typeahead suggestion based on the second prompt to obtain a second evaluation output.

12. The method of claim 1, further comprising:
iteratively training the LLM using a training prompt comprising a partial search query training input, training user profile information associated with a training user profile, a training typeahead suggestion, and a training evaluation output comprising an evaluation score and a reason for the evaluation score, and a training output comprising the training evaluation output.

13. The method of claim 1, wherein causing the LLM model to evaluate the typeahead suggestion based on the prompt further comprises:
receiving, by the LLM, an Application Program Interface (API) call comprising the prompt, wherein the prompt includes a plurality of typeahead suggestions; and
providing, to the computing device, an evaluation output for each of the plurality of typeahead suggestions in response to the API call.

14. A system comprising:
at least one processor; and
at least one memory device coupled to the at least one processor, wherein the at least one memory device comprises instructions that, when executed by the at least one processor, cause the at least one processor to perform at least one operation comprising:
obtaining a typeahead suggestion responsive to a partial search query;
creating a prompt based on the typeahead suggestion;
causing a large language model (LLM) to evaluate the typeahead suggestion based on the prompt; and
providing, to a computing device, an evaluation output by the LLM in response to the prompt.

15. The system of claim 14, wherein the prompt comprises at least one of user activity or user profile information associated with the user profile, and wherein the typeahead suggestion is one typeahead suggestion of a plurality of typeahead suggestions, and wherein the LLM provides a plurality of evaluation outputs corresponding to the plurality of typeahead suggestions.

16. The system of claim 14, wherein the instructions, when executed by the at least one processor, cause the at least one processor to perform at least one operation further comprising:
iteratively training the LLM using a training prompt comprising a partial search query training input, training user profile information associated with a training user profile, a training typeahead suggestion, and a training evaluation output comprising an evaluation score and a reason for the evaluation score, and a training output comprising the training evaluation output.

17. A non-transitory machine-readable storage medium comprising instructions that, when executed by at least one processor, cause the at least one processor to perform at least one operation comprising:
obtaining a typeahead suggestion responsive to a partial search query;
creating a prompt based on the typeahead suggestion;
causing a large language model (LLM) to evaluate the typeahead suggestion based on the prompt; and
providing, to a computing device, an evaluation output by the LLM in response to the prompt.

18. The non-transitory machine-readable storage medium of claim 17, wherein the prompt comprises at least one of user activity or user profile information associated with the user profile, and wherein the typeahead suggestion is one typeahead suggestion of a plurality of typeahead suggestions, and wherein the LLM provides a plurality of evaluation outputs corresponding to the plurality of typeahead suggestions.

19. The non-transitory machine-readable storage medium of claim 17, wherein the instructions, when executed by the at least one processor, cause the at least one processor to perform at least one operation further comprising:
iteratively training the LLM using a training prompt comprising a partial search query training input, training user profile information associated with a training user profile, a training typeahead suggestion, and a training evaluation output comprising an evaluation score and a reason for the evaluation score, and a training output comprising the training evaluation output.

20. The non-transitory machine-readable storage medium of claim 15, wherein the typeahead suggestion is generated using a first model, wherein the instructions, when executed by the at least one processor, cause the at least one processor to perform at least one operation further comprising:
generating a second typeahead suggestion using a second model, wherein the second typeahead suggestion is responsive to the partial search query;
creating a second prompt based on the second typeahead suggestion;
causing the LLM to evaluate the second typeahead suggestion based on the second prompt to obtain a second evaluation output;
comparing the second evaluation output with the evaluation output; and
flagging the first model or the second model based on the comparison of the second evaluation output with the evaluation output.
